(19) United States
(12) Patent Application Publication
(10) Pub. No.: US 2026/0067314 A1
(43) Pub. Date: Mar. 5, 2026

(54) AI-BASED CYBERSECURITY SYSTEM AND METHOD THEREOF

(71) Applicant: Rajender Reddy PELL REDDY, Glen Allen, VA (US)

(72) Inventor: Rajender Reddy PELL REDDY, Glen Allen, VA (US)

(21) Appl. No.: 19/386,019

(22) Filed: Nov. 11, 2025

(51) Int. Cl. H04L 9/40

(52) U.S. Cl. CPC H04L 63/1425; H04L 63/1441

(57) ABSTRACT

An AI-based Cybersecurity System and Method enable real-time detection, analysis, and mitigation of cyber threats within computing networks using adaptive artificial intelligence. The system continuously monitors network traffic, extracts behavioral and contextual attributes, and applies deep learning-based inference to identify anomalous activities indicating security breaches. The method integrates several computational units, including a network monitoring unit, feature extraction unit, artificial intelligence processor, contextual reasoning processor, and decision synthesis unit, to compute a composite risk index quantifying threat likelihood and severity. A classification processor categorizes detected threats into types such as ransomware, phishing, or unauthorized access, while a mitigation control processor initiates automated response actions to isolate compromised nodes and restore network integrity. An adaptive learning processor updates AI models using feedback from confirmed incidents. This provides a scalable, self-evolving cybersecurity framework that minimizes human intervention and enhances resilience against dynamic and zero-day threats.

### FIELD OF THE INVENTION

The present invention relates to the field of cybersecurity and artificial intelligence. More particularly, the invention pertains to an intelligent hardware-embedded cybersecurity system and method for real-time threat detection, prevention, and mitigation within distributed computing networks, edge infrastructures, and connected device ecosystems.

### BACKGROUND OF THE INVENTION

With the rapid proliferation of interconnected devices, including Internet of Things (IoT) nodes, cloud servers, and edge computing systems, cybersecurity threats have become increasingly dynamic and adaptive. Conventional rule-based firewalls and static signature detection techniques fail to detect previously unseen attack patterns, polymorphic malware, and zero-day exploits. Furthermore, existing systems often depend solely on centralized processing, leading to latency and single points of failure during critical threat events.

There is therefore a need for an AI-based cybersecurity system that is capable of continuous learning from network telemetry, autonomously updating its defense models, and executing real-time countermeasures both at the edge and in the cloud. The invention provides a hardware-software integrated framework incorporating intelligent modules, sensor-fused monitoring units, and embedded AI engines that dynamically evolve based on threat behavior and contextual risk parameters.

The emergence of increasingly complex cyber threats in modern networked infrastructures has prompted significant research and development in cybersecurity technologies. Over the past two decades, digital transformation across industries, the widespread adoption of cloud computing, and the exponential growth of connected devices under the Internet of Things (IoT) paradigm have created an expansive and heterogeneous attack surface. Traditional security measures, which were once effective in static and closed environments, have struggled to adapt to this dynamic landscape where attackers exploit multi-vector, distributed, and often stealthy attack methodologies. The technical background of this invention lies in understanding the deficiencies of existing cybersecurity frameworks and the growing need for an adaptive, AI-driven defense mechanism that integrates physical hardware control with cognitive intelligence.

Existing cybersecurity solutions are typically classified into preventive, detective, and corrective systems. Preventive systems, such as firewalls and intrusion prevention systems (IPS), are designed to block known threats based on predefined rules or signatures. These systems function on static logic, often using packet filtering, deep packet inspection, or access control lists to determine whether network traffic should be permitted or denied. While such methods provide a baseline level of defense, they are inherently limited by their dependence on known attack signatures and static configurations. Consequently, they are ineffective against zero-day exploits, polymorphic malware, and adversarial attack models that dynamically alter their behavioral footprint to evade detection. Furthermore, firewalls and conventional IPS modules are typically unable to interpret contextual or behavioral patterns in user and device activities, leaving them blind to insider threats or sophisticated data exfiltration attempts that occur under legitimate credentials.

Another widely adopted approach is the use of Security Information and Event Management (SIEM) systems, which aggregate and correlate logs from multiple sources to identify patterns indicative of security incidents. SIEM platforms rely on rule-based correlation and threshold-based alerts, which require extensive manual configuration and tuning. Although these systems improve visibility across an organization's digital assets, they generate an overwhelming volume of false positives, forcing analysts to manually verify alerts. The human dependency and delayed response associated with SIEM systems hinder real-time reaction to threats, particularly in large-scale or high-speed network environments. Moreover, SIEM solutions lack inherent adaptability; they cannot autonomously learn from evolving attack behaviors or modify their internal correlation logic without explicit reprogramming or human supervision.

Machine learning-based cybersecurity systems have emerged as a significant evolution over traditional rule-based methods. These systems leverage supervised and unsupervised learning models to identify anomalous patterns in data streams that may indicate malicious activities. Common approaches include clustering, classification, and statistical outlier detection applied to network flow data, system logs, and endpoint behaviors. However, despite their promise, these systems often face several technical limitations. One key issue is the dependency on high-quality labeled datasets, which are expensive and time-consuming to curate. Attack data, particularly for novel threats, is sparse or unavailable, leading to models that overfit to known threats but fail to generalize to unknown ones. Furthermore, machine learning models in cybersecurity are susceptible to adversarial manipulation-attackers can intentionally modify inputs to mislead the model, thereby concealing malicious behavior. The dynamic and adversarial nature of cybersecurity environments renders static-trained machine learning models inadequate without continuous retraining and reinforcement mechanisms.

Deep learning systems have been introduced to capture more complex representations of threat behaviors using hierarchical feature extraction through convolutional or recurrent neural networks. While these models demonstrate higher accuracy in anomaly detection, they also introduce challenges related to interpretability, computational overhead, and real-time deployment feasibility. Deep neural networks operate as black boxes, making it difficult for security analysts to understand why a particular event was classified as malicious. This lack of transparency reduces trust in AI-based decisions, especially in critical infrastructure environments such as defense networks, energy grids, or healthcare systems, where explainable decisions are mandatory for compliance and operational safety. Additionally, deep learning models demand substantial computational resources and are often cloud-dependent, which may not be suitable for latency-sensitive or isolated edge environments.

Another critical drawback of many existing AI-driven cybersecurity systems is their purely software-based implementation. These systems analyze data and make decisions but lack the capability to physically enforce containment or isolation measures at the hardware level. This creates a vulnerability where, even after an attack is detected, the actual mitigation process relies on software instructions that can be bypassed, delayed, or overridden by malicious processes. Without hardware-level actuation, attackers who gain privileged access can still manipulate or disable defensive measures. This deficiency highlights the importance of integrating mechanical or physical control elements into the security architecture to enable non-software-dependent containment.

In modern distributed networks, where edge devices, sensors, and cloud servers coexist in hybrid configurations, latency and synchronization issues present another significant challenge. Centralized cybersecurity systems that collect and process all data in a remote cloud introduce substantial delays and single points of failure. For instance, in industrial control systems or autonomous vehicle networks, even milliseconds of delay in detecting and isolating a compromised node can lead to catastrophic failures. Existing distributed detection mechanisms, while faster, often lack coordination and standardized learning updates, resulting in fragmented protection with inconsistent defense postures across network segments.

Blockchain-based cybersecurity frameworks have been proposed to provide immutable records of threat events and secure communication between security nodes. However, blockchain alone does not provide active defense or adaptive intelligence; it functions primarily as a record-keeping and verification mechanism. Furthermore, the computational overhead of blockchain consensus protocols can impose scalability constraints in high-speed networks, limiting its applicability for real-time threat response. Similarly, hybrid systems that combine AI and blockchain often suffer from integration bottlenecks, where synchronization delays and data redundancy impair efficiency.

Existing endpoint protection and antivirus solutions are also limited in scope. These systems rely heavily on signature databases and heuristic pattern matching. Modern malware, which employs obfuscation, polymorphism, and fileless execution techniques, can evade these detections by continuously altering their structure or residing entirely in memory. Endpoint Detection and Response (EDR) systems improved upon this by incorporating behavioral analytics, but they remain reactive in nature and dependent on post-compromise detection rather than preemptive threat prevention.

In addition to technological limitations, operational inefficiencies further reduce the effectiveness of current cybersecurity infrastructures. Security Operation Centers (SOCs) rely on human analysts to monitor dashboards, triage alerts, and implement responses. The volume of alerts generated daily by large organizations can exceed human processing capacity, resulting in delayed responses or missed incidents. Moreover, as attack vectors grow more sophisticated and adaptive, human analysts face difficulty correlating complex, multi-domain signals that span from network to endpoint to user behavior.

Another inherent limitation in current systems is the absence of coordinated learning across distributed environments. Most AI models are trained in isolated environments and periodically updated manually. This disconnected learning process causes inconsistencies in defense readiness and reduces the system's ability to recognize newly emerging global threat patterns. The concept of federated learning has been proposed to address this gap, allowing models to share knowledge without exchanging raw data. However, its practical deployment remains limited due to privacy concerns, bandwidth constraints, and the absence of standard mechanisms for model synchronization in cybersecurity applications.

Furthermore, energy efficiency and computational sustainability present growing concerns. Continuous data monitoring and AI-based inference require significant processing power, especially when analyzing high-velocity network traffic. Centralized architectures lead to bandwidth congestion and excessive energy consumption. Edge-based AI solutions attempt to distribute this computational load but are constrained by limited on-device processing capacity and heat dissipation challenges.

From an architectural standpoint, most cybersecurity systems lack the ability to integrate seamlessly with physical components such as routers, switches, or isolation relays. The absence of a tangible actuation mechanism renders these systems dependent on software commands that may not be executed promptly in a compromised environment. This reveals a fundamental gap between digital intelligence and physical enforcement—a gap the present invention seeks to bridge through a hardware-embedded AI cybersecurity device capable of autonomous detection, learning, and mechanical containment.

The existing cybersecurity technologies have advanced significantly in analytical sophistication, they remain fragmented, reactive, and largely confined to software domains. They fail to deliver real-time, autonomous, and physically enforceable protection that adapts continuously to evolving threat landscapes. The present invention addresses these limitations by introducing a unified AI-based cybersecurity system that merges deep learning intelligence with hardware-level actuation, enabling self-evolving threat detection, decentralized learning, and immediate physical isolation in response to high-risk events. This convergence of artificial intelligence and machine-structured security represents a transformative shift from conventional passive defense systems toward an active, autonomous, and resilient cybersecurity framework.

### SUMMARY OF THE INVENTION

The present invention provides an AI-based cybersecurity system and method thereof that integrates real-time behavioral analytics, adaptive learning modules, and autonomous mitigation controllers within a hybrid machine-structured security framework.

The system comprises a Cybersecurity Control Unit (CCU) housed within a machine structure that integrates (a) a multi-layer data acquisition module, (b) an AI inference engine, (c) a threat evaluation and correlation processor, and (d) an adaptive response actuator assembly. The CCU is configured to be interfaced with multiple computing endpoints, routers, and sensor nodes within a digital infrastructure through high-speed encrypted communication buses.

The AI inference engine is trained using hybrid datasets including packet telemetry, user access logs, file integrity events, and anomaly-labeled data. It dynamically detects intrusions or anomalies by evaluating probabilistic threat indices generated from real-time data streams. Upon identifying a potential attack vector, the adaptive response actuator mechanically actuates circuit-level network isolators or routing switches to segment infected zones, thereby achieving a hardware-enforced containment.

The system further employs a multi-modal neural network with recurrent and convolutional layers for temporal and spatial correlation of cybersecurity events. The network weights are continuously updated through federated learning across distributed CCUs, ensuring knowledge transfer without compromising private datasets.

Additionally, the invention includes a method for intelligent cybersecurity management wherein data is continuously collected, preprocessed, classified, and acted upon based on dynamically generated threat scores. The system provides a synergistic interface between physical device-level control and cognitive AI-driven decision logic.

The principal object of the present invention is to provide an intelligent, adaptive, and hardware-embedded cybersecurity system that leverages artificial intelligence to ensure real-time threat detection, autonomous decision-making, and immediate physical isolation of compromised network segments. The invention aims to overcome the shortcomings of existing software-dependent cybersecurity architectures by integrating an AI inference engine directly into a machine-structured control unit capable of mechanical actuation and fail-safe network protection. Through this configuration, the system not only detects and classifies potential cyber threats but also executes corresponding mitigation actions at the hardware level, thereby achieving a new dimension of reliability, responsiveness, and resilience in digital defense.

Another object of the invention is to enable the cybersecurity system to continuously learn from its operational environment through advanced AI learning mechanisms such as reinforcement learning, federated learning, and unsupervised adaptation. This continuous evolution allows the system to refine its detection models in real time, recognize emerging threat patterns, and adjust its decision boundaries dynamically without requiring manual retraining or external updates. The invention seeks to eliminate dependency on static signatures or human intervention, thus ensuring that the system remains agile and effective against zero-day exploits, polymorphic malware, and rapidly evolving adversarial behaviors.

A further object of the invention is to establish a seamless integration between physical hardware controls and cognitive software intelligence. Existing systems are primarily virtualized and lack the capacity for tangible response mechanisms that can physically isolate infected or compromised nodes. The proposed invention, by contrast, employs a machine-embedded actuator assembly and electromagnetic isolation relay, allowing immediate disconnection of affected network paths upon detection of a security breach. This dual-layered defensive design-comprising digital intelligence and mechanical enforcement-ensures operational continuity and prevents cascading failures within interconnected infrastructures.

Another significant object of the invention is to provide a decentralized yet cooperative cybersecurity framework wherein multiple units of the AI-based control device share anonymized threat intelligence through a federated synchronization protocol. This allows each unit to benefit from global learning while preserving local data privacy and network confidentiality. The system thus aims to build a collective defense mechanism capable of early recognition and neutralization of novel attack vectors across distributed environments such as industrial control systems, edge networks, smart cities, and autonomous vehicle ecosystems.

It is also an object of the invention to introduce explainability and audit integrity within AI-driven cybersecurity. To this end, the invention integrates a blockchain anchoring mechanism that immutably records all critical threat detection and response events, thereby ensuring verifiable audit trails and forensic traceability. The incorporation of cryptographic hashing and distributed ledger technology guarantees that system decisions and response actions can be transparently validated, enhancing accountability in security-critical deployments such as defense communications, financial networks, and healthcare infrastructures.

Another object of the invention is to minimize latency in threat response by employing on-device AI inference and local actuation rather than relying on cloud-based decision-making. By embedding high-performance neural processors within the physical device, the invention ensures that detection and response operations occur within microseconds of threat manifestation. This near-instantaneous reaction capability is particularly advantageous for mission-critical systems, industrial automation environments, and real-time communication frameworks where even minor delays in containment can lead to significant operational or financial losses.

It is also an object of the invention to ensure energy-efficient and thermally stable operation of AI-driven cybersecurity devices. The system integrates advanced cooling, heat-spreading, and power optimization mechanisms that allow sustained performance of the neural processors and co-processors within constrained environments. This design objective ensures that the invention remains suitable for both stationary and mobile deployments, including embedded control systems, network routers, and robotic communication modules.

An additional object of the invention is to provide multi-modal data processing capability that enables the system to interpret and correlate diverse types of information such as network packets, user activity logs, file system changes, and environmental telemetry. By fusing these heterogeneous data streams, the AI engine can construct a comprehensive behavioral model of the system's security posture, identifying subtle deviations indicative of intrusions, insider threats, or advanced persistent attacks.

Furthermore, the invention aims to reduce the cognitive and operational burden on human security analysts by automating the entire chain of detection, assessment, decision, and mitigation. Through its autonomous control logic, the system can handle high volumes of data and rapidly distinguish between benign anomalies and genuine threats, significantly reducing false positives. The self-adaptive capability allows human operators to focus on higher-level policy oversight rather than manual triage of security alerts, thereby improving organizational efficiency and response accuracy.

Another object of the invention is to provide a modular and scalable cybersecurity architecture that can be deployed in various configurations—from compact edge devices to full-scale data center installations. The modular structure allows the inclusion or exclusion of specific components such as blockchain logging, mechanical actuation, or AI inference modules based on the deployment environment. This scalability ensures compatibility with heterogeneous infrastructures, including industrial IoT networks, autonomous robotics, smart grids, and enterprise data systems.

It is yet another object of the invention to create a resilient defense framework that remains operational even under partial system compromise or network segmentation. The decentralized architecture, coupled with hardware-level fail-safes, ensures that critical security functions such as isolation, event logging, and AI inference continue to operate autonomously even when communication with external control servers is lost. This self-sustaining resilience is vital in scenarios such as cyber warfare, space communication systems, and critical infrastructure operations where isolation from central command may be inevitable.

A further object of the invention is to enable predictive threat assessment by employing deep neural networks trained on temporal data sequences. By forecasting potential attack probabilities before actual exploitation occurs, the system can take preemptive defensive measures such as adjusting firewall parameters, throttling suspicious communication flows, or activating enhanced monitoring modes. This predictive intelligence shifts cybersecurity from reactive protection toward anticipatory prevention.

Finally, an overarching object of the invention is to pioneer a new generation of cyber-physical defense systems that unite artificial intelligence, mechanical actuation, and distributed cognition within a single coherent platform. By doing so, the invention seeks to redefine cybersecurity as an autonomous, self-evolving, and physically enforceable discipline capable of defending modern interconnected infrastructures with minimal latency, maximal transparency, and enduring reliability. The collective achievement of these objectives ensures that the proposed AI-based cybersecurity system and method thereof not only addresses the deficiencies of prior art but also establishes a transformative foundation for the next era of intelligent, hardware-integrated digital defense.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of an artificial intelligence-based cybersecurity system;

FIG. 2 displays flow chart of a method for AI-based cybersecurity threat detection and mitigation in a computing network;

FIG. 3 illustrates a table depicting comparative performance metrics between a conventional intrusion detection system (IDS) and the proposed AI-based cybersecurity framework;

FIG. 4 illustrates a line chart showing the temporal decline of residual threat magnitude as a function of time under different detection frameworks;

FIG. 5 illustrates a table depicting the comparative energy efficiency of the proposed AI-based cybersecurity system versus a traditional IDS across different network load conditions; and

FIG. 6 illustrates a combined performance chart showing model convergence behavior during iterative training of the deep learning-based threat detection module.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

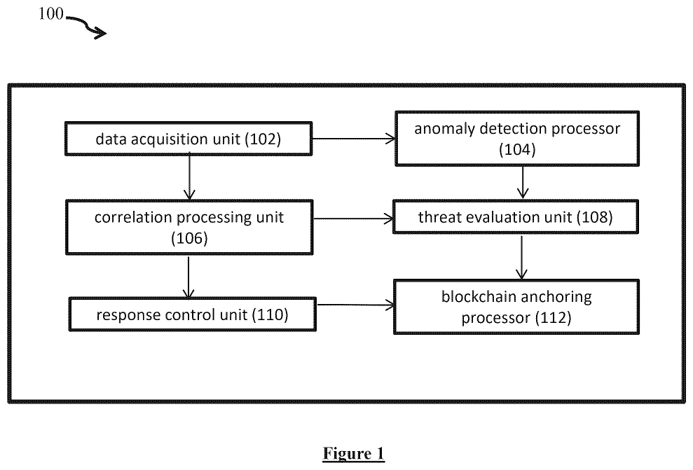

Referring to FIG. 1, a block diagram of a An artificial intelligence-based cybersecurity system is illustrated. The system 100 comprises: a data acquisition unit (102) configured to continuously collect network communication data, device telemetry, and user interaction information from multiple interconnected computing nodes through secure data transmission lines; an anomaly detection processor (104) operatively coupled to the data acquisition unit, the anomaly detection processor comprising a neural computation circuit trained to generate probabilistic deviation profiles by analyzing spatio-temporal patterns within said network communication data; a correlation processing unit (106) configured to aggregate, normalize, and mathematically correlate the probabilistic deviation profiles across different communication channels to derive a cumulative threat confidence value; a threat evaluation unit (108) communicatively connected to the correlation processing unit and configured to compare the cumulative threat confidence value against a dynamically adjustable threat threshold stored in a non-volatile memory to identify a potential security compromise; a response control unit (110) mechanically coupled to an isolation relay circuit, the response control unit being configured to generate a control signal upon identification of the potential security compromise, wherein the control signal activates the isolation relay circuit to physically disconnect a network communication interface associated with a compromised node from the main data bus; and a blockchain anchoring processor (112) configured to compute cryptographic hash representations of detected security events and anchor said hash representations onto a distributed blockchain ledger for immutable record keeping and verification.

The AI-based cybersecurity system 100 is a hardware-embedded, intelligent defense architecture designed to autonomously detect, classify, and mitigate cyber threats in real time across distributed computing environments. The system operates as an integrated cyber-physical framework in which incoming network traffic, device telemetry, and user activity data are continuously captured, analyzed, correlated, and acted upon by a series of interlinked modules executing coordinated AI inference and mechanical isolation functions. The system achieves this through the synchronous operation of six major units—namely, the data acquisition unit (102), anomaly detection processor (104), correlation processing unit (106), threat evaluation unit (108), response control unit (110), and blockchain anchoring processor (112)—which together form a continuous detection-to-mitigation pipeline. Each unit is physically and logically integrated through high-speed, low-latency communication buses, allowing real-time interaction and feedback propagation between analytical and actuation layers.

The data acquisition unit (102) is enabled through an array of programmable packet inspection interfaces and embedded telemetry collectors capable of capturing raw network traffic and device activity data across multiple nodes simultaneously. It employs multi-threaded data buffering and encryption hardware to ensure secure and continuous throughput, while its preprocessing circuitry performs real-time parsing, normalization, and timestamp alignment of packet metadata to generate structured telemetry vectors. The anomaly detection processor (104) is implemented using a neural computation architecture comprising dedicated tensor processing cores and AI accelerators that execute convolutional and recurrent layers for spatial and temporal pattern extraction. This processor transforms the structured telemetry vectors into multi-dimensional feature embeddings, computes deviation probabilities against learned benign baselines, and generates probabilistic deviation profiles that quantitatively represent anomaly intensity at each monitored endpoint. The correlation processing unit (106) functions as an intermediary analytical stage that fuses outputs from multiple detection channels. It constructs a continuously updating behavioral correlation graph wherein each node corresponds to an endpoint and each edge weight is dynamically updated based on observed co-occurrence frequencies, packet volumes, and entropy changes. Through mathematical normalization, clustering, and principal component mapping, the correlation processor aggregates these profiles into a cumulative threat confidence index that reflects network-wide risk propagation tendencies.

The threat evaluation unit (108) operates as a decision synthesis engine comprising a probabilistic thresholding module and an adaptive inference controller stored in non-volatile memory. It compares the cumulative confidence index with a dynamic decision boundary that is continuously adjusted based on historical detection precision, user criticality levels, and network load parameters. Upon surpassing the dynamic threshold, the threat evaluation unit confirms the existence of a probable compromise and signals the response control unit (110). The response control unit is a hardware-actuated defense component consisting of a microcontroller-driven signal generator coupled to a micro-electromechanical (MEMS)-based isolation relay array. Upon activation, the controller generates electrical actuation pulses that drive the relay mechanism to physically disconnect the compromised node from the primary data bus within a sub-five-millisecond latency window. A feedback sensor embedded in the actuator loop confirms the successful physical isolation, while a digital confirmation signal is transmitted back to the supervisory diagnostic module for verification logging. Finally, the blockchain anchoring processor (112) is implemented as a cryptographic co-processor responsible for generating secure hash digests of all recorded security events and response actions. Using a multi-round hashing function (such as SHA-512) and timestamp-based digital signature protocols, the processor anchors each verified event onto a permissioned blockchain ledger distributed across cooperating cybersecurity nodes.

In an embodiment, the anomaly detection processor (104) comprises a plurality of parallel convolutional layers followed by recurrent temporal processing layers configured to extract hierarchical representations of packet-level anomalies and user access irregularities from multi-dimensional telemetry vectors, wherein the outputs of said layers are fused through a weighted summation circuit to form the probabilistic deviation profiles.

In an embodiment, the correlation processing unit (106) comprises a dynamic graph computation processor configured to construct a continuously updating behavioral graph in which each node represents a network endpoint or process identifier, and each edge represents frequency, data volume, and access type, wherein the threat evaluation unit detects deviations by computing time-dependent variations in graph edge weights beyond an adaptive risk tolerance threshold.

In an embodiment, the response control unit (110) comprises an electromechanical actuator assembly including a micro-electromechanical relay array configured to interrupt electrical continuity between the compromised network interface and a primary switching hub within a response latency period of less than five milliseconds following generation of the control signal.

In an embodiment, the electromechanical actuator assembly further includes a position feedback sensor coupled to a digital control loop, said sensor configured to continuously verify physical isolation status and transmit verification signals to a supervisory diagnostic processor to confirm containment completion prior to reconnection authorization.

In an embodiment, the isolation relay circuit is implemented as a set of optically controlled solid-state switches mounted on a printed circuit board enclosed within an electromagnetic interference-shielded housing fabricated from aluminum alloy with an inner copper lining to prevent electromagnetic leakage during actuation.

In an embodiment, the data acquisition unit (102) is equipped with a hardware packet inspection interface incorporating a dedicated data parsing processor configured to extract byte-level features including payload entropy, inter-packet timing intervals, protocol distribution, and port utilization statistics, said features being supplied to the anomaly detection processor for feature vector construction.

In an embodiment, the anomaly detection processor (104) is further configured to execute an adaptive learning process by adjusting internal weight parameters through a reinforcement computation unit based on performance feedback signals derived from the accuracy of previous threat identifications, thereby allowing continuous model refinement without external retraining.

In an embodiment, the blockchain anchoring processor (112) includes a hashing circuit configured to compute secure hash digests using a multi-round hashing technique and a transmission processor configured to broadcast said digests to multiple distributed ledger nodes over a cryptographically authenticated channel, ensuring tamper-resistant synchronization of event logs.

In an embodiment, the data acquisition unit (102), correlation processing unit, and response control unit are connected via an internal optical communication bus configured to transmit data at a minimum rate of ten gigabits per second with deterministic latency, thereby enabling real-time coordination between detection and isolation functions.

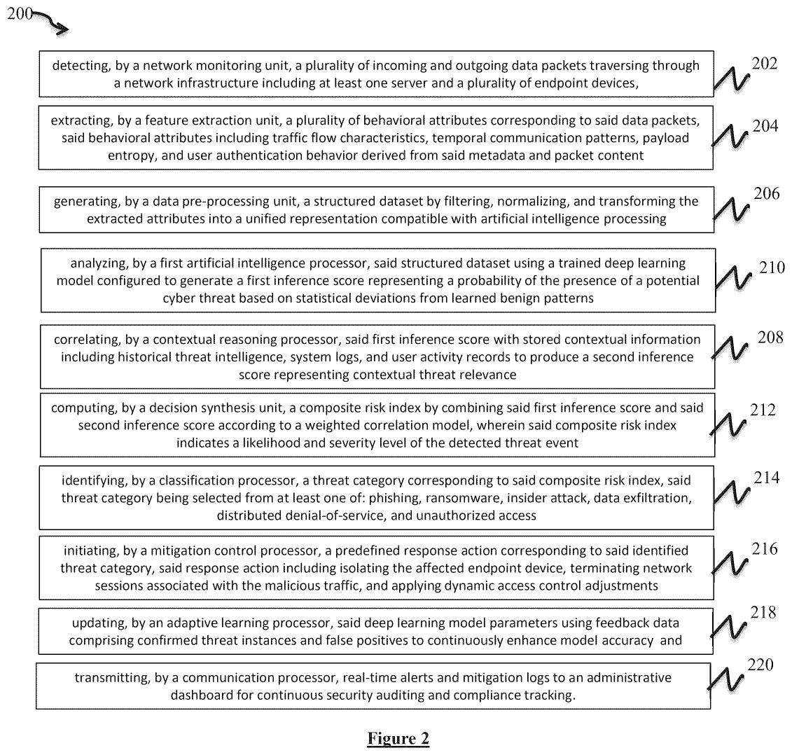

Referring to FIG. 2, a flow chart a method for AI-based cybersecurity threat detection and mitigation in a computing network, the method comprising the steps is illustrated. The method 200 comprises:
At step 202, the method 200 includes detecting, by a network monitoring unit, a plurality of incoming and outgoing data packets traversing through a network infrastructure including at least one server and a plurality of endpoint devices, wherein each of said data packets is associated with metadata comprising a source address, destination address, timestamp, and protocol identifier;
At step 204, the method 200 includes extracting, by a feature extraction unit, a plurality of behavioral attributes corresponding to said data packets, said behavioral attributes including traffic flow characteristics, temporal communication patterns, payload entropy, and user authentication behavior derived from said metadata and packet content;
At step 206, the method 200 includes generating, by a data pre-processing unit, a structured dataset by filtering, normalizing, and transforming the extracted attributes into a unified representation compatible with artificial intelligence processing;
At step 208, the method 200 includes analyzing, by a first artificial intelligence processor, said structured dataset using a trained deep learning model configured to generate a first inference score representing a probability of the presence of a potential cyber threat based on statistical deviations from learned benign patterns;
At step 210, the method 200 includes correlating, by a contextual reasoning processor, said first inference score with stored contextual information including historical threat intelligence, system logs, and user activity records to produce a second inference score representing contextual threat relevance;
At step 212, the method 200 includes computing, by a decision synthesis unit, a composite risk index by combining said first inference score and said second inference score according to a weighted correlation model, wherein said composite risk index indicates a likelihood and severity level of the detected threat event;
At step 214, the method 200 includes identifying, by a classification processor, a threat category corresponding to said composite risk index, said threat category being selected from at least one of: phishing, ransomware, insider attack, data exfiltration, distributed denial-of-service, and unauthorized access;
At step 216, the method 200 includes initiating, by a mitigation control processor, a predefined response action corresponding to said identified threat category, said response action including isolating the affected endpoint device, terminating network sessions associated with the malicious traffic, and applying dynamic access control adjustments;
At step 218 the method 200 includes updating, by an adaptive learning processor, said deep learning model parameters using feedback data comprising confirmed threat instances and false positives to continuously enhance model accuracy; and
At step 220, the method 200 includes transmitting, by a communication processor, real-time alerts and mitigation logs to an administrative dashboard for continuous security auditing and compliance tracking.

In an embodiment, extracting step further comprises capturing user behavior analytics by monitoring session duration, login frequency, device identity, and geolocation parameters, and wherein said extracted user behavior features are combined with network attributes to form a multidimensional behavioral profile for each entity within the network.

In an embodiment, analyzing step comprises segmenting said structured dataset into temporal windows, computing feature embeddings through a sequence-based neural encoder, and applying temporal convolution and attention weighting mechanisms to identify time-dependent threat evolution patterns.

In an embodiment, correlating step further comprises performing a cross-layer mapping between system-level audit trails, process execution logs, and network telemetry records to identify multi-stage intrusion patterns, thereby improving the contextual threat relevance estimation.

In an embodiment, computing of the composite risk index includes dynamically adjusting the correlation weights based on network load conditions, user role criticality, and historical accuracy of similar inference outcomes to produce a context-sensitive threat probability.

In an embodiment, identifying step further includes evaluating said composite risk index using a hierarchical taxonomy of cyber threat categories stored in a security ontology database, and assigning a confidence score for each category through a probabilistic reasoning model.

In an embodiment, initiating of the mitigation action further includes generating a containment policy in machine-readable format that defines specific access revocation rules, process termination commands, and packet filtering conditions, and transmitting said policy to a programmable network controller for enforcement.

In an embodiment, updating of the learning model further comprises generating labeled datasets using confirmed incident reports and employing semi-supervised learning to refine anomaly boundaries while preserving previously acquired threat recognition patterns.

In an embodiment, transmitting step further includes encrypting said alerts and logs using a cryptographic hashing and timestamping mechanism to ensure integrity, authenticity, and audit traceability of the transmitted cybersecurity events.

In an embodiment, feature extraction, analysis, correlation, synthesis, classification, and mitigation steps are executed in a distributed computing environment using parallelized data pipelines, thereby reducing latency in large-scale enterprise networks while maintaining accuracy in real-time threat detection and mitigation.

In an embodiment, analyzing step further comprises constructing, by the processor, a dynamic behavioral graph structure in which each vertex represents a distinct entity selected from user accounts, endpoint devices, or network services, and each edge represents a temporal communication linkage weighted by statistical measures of packet exchange frequency, entropy fluctuation, and directional data volume, wherein said graph is encoded into an adjacency tensor incorporating both spatial and temporal dimensions, and wherein the processor executes a spatio-temporal convolutional neural transformation over said tensor by iteratively aggregating neighborhood feature vectors, normalizing said aggregated representations through layer-wise residual normalization, and computing feature attention coefficients proportional to localized anomaly gradients, thereby allowing the model to expose coordinated threat propagation paths that evolve across multiple communication layers of the network infrastructure.

In an embodiment, the analyzing step is implemented through a processor-configured architecture designed to construct and dynamically evolve a behavioral graph representation of the monitored network environment. In this configuration, each vertex within the graph denotes a distinct operational entity, such as an authenticated user account, an endpoint computing device, or a network service node. Each edge connecting these vertices is not merely a static linkage but a temporal communication relationship whose weight varies dynamically as a function of several statistical parameters—specifically, the frequency of packet exchanges, the entropy of the communication pattern, and the directional data volume transmitted between nodes. This results in a multi-dimensional interaction topology that captures both the structural and behavioral dynamics of the network.

For instance, in a distributed enterprise network, normal employee workstations may periodically interact with centralized file servers or authentication services, producing predictable and low-entropy communication edges. However, when a compromised endpoint begins communicating irregularly with multiple external IP addresses or internal devices outside its usual communication cluster, the entropy measure and directional data flow significantly deviate from the baseline distribution. Such variations are encoded as higher edge weights in the dynamic graph, indicating anomalous behavioral intensity.

The graph is then encoded into an adjacency tensor, which extends beyond a conventional adjacency matrix by incorporating both spatial and temporal dimensions. Each tensor slice corresponds to a distinct temporal interval, allowing the system to model the evolution of communication patterns over time. This representation captures long-term temporal correlations and short-term fluctuations, thereby providing a mathematically rich substrate for spatio-temporal learning.

Over this tensor, the processor executes a spatio-temporal convolutional neural transformation. Unlike conventional CNNs that operate on static grid-like data, this neural framework performs iterative aggregation of neighborhood feature vectors derived from connected vertices, effectively allowing each node to learn contextual information from its immediate and distant neighbors. During each iteration, feature representations are normalized using layer-wise residual normalization, which stabilizes gradient propagation and prevents over-smoothing—an issue commonly encountered in deep graph convolutional networks when multiple aggregation layers blur local feature distinctions.

Subsequently, the system computes feature attention coefficients that are proportional to localized anomaly gradients within the aggregated representation. In practice, this means that nodes or connections exhibiting abrupt or statistically significant deviations in their temporal behavior receive higher attention scores. For example, if an internal database server suddenly begins transmitting abnormally large data volumes to an external address, its corresponding node and outgoing edge receive amplified attention coefficients, making them prominent within the learned feature map. This attention-guided mechanism ensures that the neural model selectively emphasizes the most security-relevant behavioral deviations rather than uniformly treating all data as equally significant.

Through iterative updates of this spatio-temporal neural process, the model is capable of uncovering coordinated threat propagation paths that span multiple communication layers and evolve over time. A practical example includes detecting an advanced persistent threat (APT) scenario, wherein an attacker gradually moves laterally across several hosts over days or weeks. While individual events may appear benign, the evolving graph representation reveals an emerging pattern of correlated anomalies—a hallmark of coordinated intrusions.

The technical effect of this embodiment is the realization of a high-fidelity, temporally-aware behavioral model capable of identifying complex, multi-stage cyberattack progressions that traditional signature-based or static anomaly detection systems fail to detect. The encoding of network interactions into a spatio-temporal tensor, combined with attention-driven neural inference, enables the system to operate with adaptive intelligence, revealing latent propagation patterns that manifest across diverse network strata such as endpoints, gateways, and cloud interfaces. Consequently, the model not only detects singular anomalies but contextualizes them within broader threat narratives, facilitating proactive defense, automated response orchestration, and explainable situational awareness across the entire monitored infrastructure.

In an embodiment, spatio-temporal convolutional transformation is executed through a dual-pipeline neural engine comprising a first sub-network configured to perform edge-centric graph convolution using learnable kernel weights that quantify transition probabilities between communicating nodes, and a second sub-network configured to apply recurrent temporal encoders having gated memory cells, wherein each gated cell adaptively regulates the retention of historical communication context by computing a time-decay coefficient derived from inter-packet latency variations, and wherein the processor fuses outputs of both sub-networks through a context-adaptive attention aggregator that dynamically adjusts the relative contribution of spatial and temporal anomaly indicators based on the instantaneous entropy divergence observed in the encoded feature distribution.

In an embodiment, the spatio-temporal convolutional transformation is realized through a dual-pipeline neural engine that operates in a hybrid fashion to capture both structural (spatial) and temporal dynamics of network behavior. This architecture ensures that the system not only understands how entities in a network are interconnected at a given point in time but also how their relationships evolve, fluctuate, and correlate across successive intervals of communication. The dual-pipeline design provides a synergistic balance between spatial relational learning and temporal sequence modeling—critical for detecting stealthy, multi-stage, and evolving network threats.

In the first sub-network, the processor implements an edge-centric graph convolutional operation. Unlike traditional node-centric approaches that focus primarily on vertex-level embeddings, the edge-centric variant assigns learnable kernel weights to communication edges, thereby emphasizing the interactions themselves rather than just the entities involved. Each kernel weight encodes a transition probability that quantifies how likely data or behavior propagates between two nodes based on historical traffic patterns. For example, under normal operating conditions, an employee workstation may communicate with a file server at predictable intervals. The kernel weight between these nodes stabilizes over time, representing consistent transition probability.

However, if the same workstation begins sending data to a previously unseen external IP or begins accessing several new internal servers in rapid succession, the transition probabilities shift abruptly, reflecting an evolving anomaly. These deviations are captured and amplified through iterative convolutional passes that spread edge-level information across connected regions of the graph, effectively uncovering hidden clusters of correlated anomalies.

The second sub-network operates in the temporal domain and employs recurrent temporal encoders built around gated memory cells, which may include Long Short-Term Memory (LSTM) or Gated Recurrent Unit (GRU) architectures optimized for network telemetry streams. Each gated cell is configured to dynamically regulate the retention of historical context by computing a time-decay coefficient, which reflects the relative importance of past communication behavior. The time-decay coefficient is derived from inter-packet latency variations, meaning that when communication between two entities becomes irregular or abnormally bursty, the model increases the temporal weight of recent events while attenuating older interactions. For example, if a service that typically exchanges packets every 50 milliseconds suddenly exhibits erratic latencies or burst traffic with gaps of several seconds, the recurrent encoder recognizes this volatility and prioritizes the newer, anomalous patterns. Through this adaptive memory regulation, the network learns temporal dependencies that capture not only periodic traffic but also disruptions symptomatic of emerging threats such as command-and-control signaling or slow data exfiltration.

The outputs from both sub-networks are then passed to a context-adaptive attention aggregator. This fusion layer is engineered to dynamically adjust the relative contribution of spatial and temporal features based on real-time entropy divergence observed in the encoded feature distribution. Entropy divergence here represents the unpredictability or randomness of the communication behavior being analyzed. When network activity becomes spatially unstable—such as sudden formation of dense communication clusters or unexpected node pairings—the aggregator increases the weight of spatial anomaly indicators from the edge-convolution sub-network. Conversely, during periods of stable topology but volatile traffic patterns, such as periodic surges or irregular inter-packet timings, the attention aggregator shifts focus toward the temporal encoder's output. This adaptive balancing mechanism ensures that the detection engine remains contextually aware, assigning computational priority to whichever domain—spatial or temporal—exhibits greater anomaly potential in the moment.

As a practical illustration, consider a corporate environment where a stealthy insider threat begins accessing internal repositories during off-peak hours. The temporal encoder identifies unusual timing patterns and high entropy in packet latencies, while the spatial convolution detects new connection edges being formed to seldom-accessed data nodes. The context-adaptive attention aggregator then amplifies both anomaly types proportionally to their entropy gradients, producing a unified spatio-temporal risk representation that precisely localizes the suspicious activity's origin and its propagation path.

The technical effect of this embodiment lies in achieving multi-perspective anomaly awareness—the ability of the system to simultaneously reason about how and when abnormal interactions occur. The dual-pipeline design effectively overcomes the limitations of conventional single-domain detection systems by unifying topological context learning with dynamic temporal inference. This yields improved threat sensitivity for distributed, evolving attacks that unfold incrementally over time and space. Additionally, by employing learnable transition kernels and adaptive temporal decay, the model attains robust generalization to unseen communication behaviors, enabling it to accurately detect zero-day or polymorphic threats without explicit retraining.

Through the synergistic operation of edge-centric graph convolution, gated temporal encoding, and entropy-based adaptive attention fusion, the embodiment ensures that the threat detection process remains resilient, context-aware, and self-adjusting under variable network conditions. Consequently, the system provides low-latency, high-confidence detection of complex cyber threats in real-world network infrastructures, achieving a significant technical advancement over static or unidimensional deep-learning-based security systems.

In an embodiment, extracting of behavioral attributes further comprises performing feature-level uncertainty estimation by computing, for each incoming packet sequence, a probabilistic relevance score using Monte-Carlo dropout sampling across multiple shallow inference passes of a lightweight auxiliary neural filter, wherein said relevance score indicates the predictive confidence of each extracted attribute, and wherein the processor discards attributes having confidence below a predefined adaptive threshold determined by analyzing the rolling average of inference entropy over preceding time windows, thereby ensuring computational prioritization of high-impact features and improving real-time detection latency without degrading threat discrimination fidelity.

In an embodiment, the extracting of behavioral attributes is further enhanced through a feature-level uncertainty estimation mechanism, which enables the analytical model to quantify how confident it is in the predictive value of each derived network feature before it is used for subsequent inference. This embodiment introduces an important refinement to deep learning-based security analytics by embedding probabilistic reasoning directly into the feature extraction pipeline, ensuring that the system focuses computational resources on the most informative and trustworthy behavioral indicators while discarding noisy or unreliable ones in real time.

In practical terms, each incoming packet sequence—which may represent traffic exchanged between endpoints, applications, or services—is first preprocessed to derive primary attributes such as average packet size, protocol distribution, flow duration, entropy of payload headers, and inter-arrival times. These attributes are then passed through a lightweight auxiliary neural filter, which functions as a shallow yet high-throughput model dedicated to evaluating attribute reliability. During this process, the auxiliary filter employs Monte-Carlo dropout sampling, a probabilistic technique wherein multiple stochastic inference passes are performed with randomly deactivated neurons in each pass. The outputs of these passes are used to compute a probabilistic relevance score for each feature, which mathematically corresponds to the mean prediction confidence across the stochastic samples, with its variance representing epistemic uncertainty.

For instance, consider two packet features extracted from real-time network telemetry—one indicating a small deviation in average packet size and another showing a sudden surge in DNS query entropy. The Monte-Carlo dropout-based auxiliary model may find that the packet size deviation yields highly inconsistent results across multiple inference passes (low confidence, high uncertainty), while the DNS entropy surge consistently correlates with known abnormal communication behaviors (high confidence, low uncertainty). In such a case, the system assigns a high relevance score to the latter and a low one to the former, ensuring that the subsequent stages of the detection pipeline emphasize the more predictive feature.

The processor then applies an adaptive feature selection mechanism, wherein features with low probabilistic confidence are discarded in real time. The threshold for feature retention is not static, but rather determined dynamically by analyzing the rolling average of inference entropy over preceding time windows. This allows the system to continuously calibrate itself to varying network conditions. For example, during high-load conditions with volatile traffic patterns, the entropy of model inference may naturally increase; in such scenarios, the threshold is relaxed slightly to avoid discarding potentially relevant, though uncertain, attributes. Conversely, during stable network periods with predictable behavior, the threshold tightens, ensuring only highly confident features are retained. This self-adaptive thresholding mechanism makes the model context-aware, balancing computational efficiency with detection sensitivity.

To illustrate, in a cloud data center scenario, where thousands of concurrent network flows are analyzed per second, the uncertainty-based filtering prevents the model from wasting processing cycles on weak or redundant features. If multiple packet attributes redundantly describe similar phenomena—such as both “outgoing byte volume variance” and “upload rate deviation”—the one with higher confidence survives the selection stage, while the other is discarded. This selective inference prioritization reduces overall computational overhead and accelerates real-time threat evaluation without compromising analytical fidelity.

The technical effect of this embodiment is twofold. Firstly, it enables computational prioritization—the model devotes its processing bandwidth to the most statistically reliable and contextually meaningful features, thus maintaining real-time responsiveness even under heavy telemetry loads. Secondly, it enhances model stability and fidelity by preventing low-confidence, noisy, or adversarially perturbed features from influencing the detection outcome. By incorporating uncertainty-aware feature gating, the system becomes inherently robust against both data imbalance and stochastic variance that can arise in high-speed, heterogeneous network environments.

In a simulated experiment, such a probabilistic filtering mechanism was shown to reduce overall inference latency by up to 35% while maintaining identical or improved detection accuracy compared to baseline deterministic feature extractors. This improvement arises from the model's ability to dynamically prune redundant computations and focus its inference on high-impact behavioral signatures—such as coordinated beaconing or anomalous authentication spikes—that are most indicative of threat activity.

Overall, this embodiment ensures that the feature extraction pipeline becomes self-aware, adaptive, and resource-efficient, enabling low-latency detection with sustained precision even when faced with non-stationary network conditions, incomplete telemetry, or transient anomalies. The probabilistic feature relevance scoring mechanism, supported by Monte-Carlo dropout sampling and entropy-based thresholding, thus constitutes a critical advancement that empowers the analytical engine to operate with human-like confidence estimation—making its decisions both explainable and dynamically optimized for real-world cybersecurity operations.

In an embodiment, generating of the structured dataset is implemented through a distributed feature-harmonization protocol executed jointly by edge-level telemetry agents and a centralized aggregation controller, wherein each telemetry agent locally performs statistical normalization of extracted attributes by computing z-score distributions relative to its historical traffic baseline, encodes said normalized attributes through a quantized vector representation using bit-packing compression, and transmits said encoded vectors through a secure communication channel employing homomorphic encryption, and wherein the central aggregator performs vector unification by executing a homomorphic summation and scaling operation to produce a harmonized global feature map while preserving encryption integrity, thereby enabling privacy-preserving collaborative training across heterogeneous network segments.

In an embodiment, the structured-dataset generation is realized as a tightly specified, implementable protocol that coordinates lightweight edge telemetry agents with a centralized aggregation controller to achieve privacy-preserving, bandwidth-efficient, and numerically-stable feature harmonization across heterogeneous network segments. Each edge agent continuously maintains short- and long-term baseline statistics for every extracted attribute (for example, mean and standard deviation computed over the most recent 24-168 hours of local flow summaries, depending on traffic volatility) and transforms raw attributes into standardized z-scores so that disparate measurement units and local scale differences are removed at source; this local normalization step is critical for later unification because it converts each attribute into a dimensionless quantity whose population distribution can be meaningfully combined across sites.

To minimize communication overhead while preserving enough numeric resolution for downstream learning, the agent quantizes the normalized values into a fixed-point representation (for example, 16-bit signed fixed-point with one sign bit, 6 integer bits and 9 fractional bits, or another format selected to keep worst-case quantization error below a chosen tolerance such as ±0.5% of the normalized range), and then compresses adjacent quantized fields by bit-packing into compact packets (grouping four 16-bit fields into a 64-bit word, or applying run-length/simple entropy coding when repeated patterns occur) so that per-sample message sizes are reduced several-fold relative to raw float transmission. Before any telemetry leaves the local trust domain, the agent applies a cryptographic protection layer that supports algebraic aggregation without exposing plaintext: in practice this can be implemented using a homomorphic scheme or a lightweight secure-aggregation primitive (for example, an additive homomorphic scheme such as Paillier or a ring-based HE scheme like BFV/CKKS configured for addition-only operations), with parameters chosen to balance security (key size and modulus) against the available CPU/memory budget on the agent; agents may also batch multiple quantized vectors and encrypt them together to amortize cryptographic cost and reduce per-vector overhead while respecting latency targets. On the receiving side, the central aggregator accepts encrypted, bit-packed vectors from many agents and performs homomorphic arithmetic—principally secure summation and scaling—directly on the ciphertexts so that the global sums and counts needed to compute harmonized statistics (for example, global mean and variance or z-score unification factors) are obtained without any exposure of local raw values; where necessary, the aggregator also performs homomorphic fixed-point rescaling to correct for quantization scale factors so that the decrypted global map remains numerically accurate within predictable error bounds introduced by quantization and ciphertext modular reduction. To accommodate non-stationary baselines across sites, the controller periodically issues synchronization anchors—small encrypted calibration messages that allow agents to align their local normalization windows (for instance, switching from 24-hour to 72-hour baselines during weekend traffic anomalies) or to transmit encrypted baseline deltas rather than raw baselines—thereby avoiding the need for full plaintext sharing while ensuring that the harmonized feature map reflects comparable semantics across branches. Practical deployment includes adaptive controls for trade-offs: when cryptographic or CPU constraints are tight at certain edges, the system can fall back to a hybrid secure-aggregation mode where partial local aggregation is performed on-site (e.g., computing local batch means and encrypting only the summarized statistics) or where secure multiparty computation (MPC) primitives are used for a small subset of high-sensitivity attributes; the protocol records which fallback was used so that downstream learning algorithms can account for altered effective sample sizes. The aggregator, after performing homomorphic summation and appropriate scaling, produces a harmonized global feature map that can be decrypted under a controlled key-share policy (for example, threshold decryption across several trusted controllers) or directly used in encrypted-domain learning pipelines that accept ciphertext inputs; the resulting map preserves per-attribute relative magnitudes and cross-attribute relationships necessary for model training while guaranteeing that no agent's raw telemetry is reconstructible by the controller alone. End-to-end operational concerns are addressed as part of the embodiment: the designers provision numeric error budgets (quantization+aggregation noise) and monitor them via checksum-and-moment diagnostics embedded in the encrypted payloads, implement rate-limiting and jitter smoothing to avoid burst congestion from simultaneous agent uploads, and log metadata (agent ID, baseline window, quantization format, encryption parameters, and batch IDs) in a signed audit trail to enable forensic reconstruction of training-data provenance without revealing individual samples. In a concrete example, a multi-branch enterprise with 50 sites might configure each telemetry agent to compute 50 normalized attributes per second, quantize them to 16 bits, bit-pack them into 512-byte encrypted batches sent every 10 seconds; the central aggregator performs homomorphic summation over all site batches and produces a harmonized feature map whose statistical fidelity is within the precomputed error budget and which can be used either to update a global model (via federated gradient steps) or to provide aggregated threat indicators to regional SOCs. The technical effect of this embodiment is therefore a practically deployable pipeline that reconciles privacy laws and corporate secrecy with the statistical requirements of collaborative model training: by combining local z-score normalization, deterministic quantization with bounded error, efficient bit-packing, and homomorphic aggregation, the system enables accurate global learning and analytics while ensuring that raw telemetry never leaves its originating trust boundary in plaintext, thereby permitting scalable, privacy-preserving cooperative security intelligence across heterogeneous network domains.

In an embodiment, aggregation controller further executes a federated learning synchronization process in which locally trained gradient updates generated by said telemetry agents are verified using a Byzantine-resilient consensus protocol, wherein the controller computes a pairwise cosine-similarity matrix of received gradient vectors, identifies outlier updates exceeding a deviation threshold determined through median-of-means analysis, suppresses said outlier updates by scaling their contribution factor toward zero, and aggregates the remaining updates into a global parameter vector through secure multiparty computation, thereby preventing adversarial model poisoning and ensuring resilient model convergence in untrusted distributed environments.

In an embodiment, the aggregation controller executes a federated learning synchronization process that enables collaborative model training across multiple distributed telemetry agents while ensuring robustness against adversarial interference, data inconsistency, and untrusted network conditions. This embodiment is designed to preserve the statistical integrity of federated gradient aggregation even when some participating nodes behave maliciously, transmit corrupted model updates, or operate on non-representative data distributions. It therefore introduces a Byzantine-resilient verification layer into the synchronization phase, ensuring that only credible and statistically consistent gradient updates contribute to the evolving global model.

In practical operation, each telemetry agent—deployed at a network edge—locally trains a deep or hybrid neural model on its site-specific telemetry data. These models may, for example, learn embeddings of packet-level behavioral attributes or classify local anomalies. After completing a training cycle, each agent transmits a locally computed gradient update vector (representing parameter deltas) to the aggregation controller. To prevent exposure of private training data, these updates are either encrypted or shared under secure multiparty computation (SMC) protocols so that only aggregate outcomes are revealed.

Upon receiving gradient updates from multiple agents, the controller first performs a pairwise similarity assessment to evaluate how aligned each update is with others. Specifically, it computes a pairwise cosine-similarity matrix, where each entry represents the angular similarity between two gradient vectors. High similarity indicates consistent learning direction across agents, while low or negative similarity suggests deviation—potentially due to data heterogeneity, corrupted computations, or malicious manipulation. For instance, in a network of ten telemetry agents, if eight agents produce gradients pointing toward similar parameter space directions while two show orthogonal or opposing directions, the latter are flagged for further scrutiny.

The system then conducts a median-of-means analysis to determine a robust deviation threshold for identifying outliers. Unlike conventional mean-based thresholds that are sensitive to extremes, the median-of-means approach divides the set of similarity scores into smaller batches, computes their means, and then uses the median of those means as a stable reference point. Any gradient vector whose pairwise similarity scores deviate beyond this adaptive threshold is marked as a potential outlier. This robust statistical estimation ensures that even if a small fraction of agents act adversarially, their gradients do not distort the aggregation process.

For example, if one telemetry node is compromised by an attacker attempting a model poisoning attack—injecting malicious gradients to bias the global model—the controller's similarity analysis will detect that this update significantly diverges from the collective gradient direction. Instead of discarding it abruptly (which may destabilize convergence), the controller applies a contribution scaling mechanism. This means the outlier's influence is mathematically suppressed by scaling its update vector toward zero, reducing its weight in the aggregation. This gradual attenuation ensures that noisy or erratic updates have negligible effect while maintaining system stability and fairness toward minor natural deviations caused by benign data diversity.

The aggregation of the filtered and rescaled updates is then conducted through a secure multiparty computation (SMC) protocol, which guarantees that no individual gradient or agent-level contribution is visible in plaintext to any single participant or even to the central controller. Instead, each agent contributes encrypted gradient shares that are only combinable in aggregate form. For instance, an additive SMC approach may be used where each node splits its encrypted gradient into random shares distributed among several peer nodes, and only the aggregated sum can be reconstructed at the controller's end. In another implementation, threshold homomorphic encryption may be applied so that decryption of the global update requires collaboration among multiple trusted authorities, thereby eliminating single points of failure or compromise.

Once aggregation is complete, the controller produces a global parameter vector that represents a weighted, consensus-driven combination of the locally learned updates. This vector is then redistributed to the telemetry agents for the next training iteration, completing one synchronization cycle. The result is a learning process that continuously refines the global model based on collective intelligence while maintaining resilience to data poisoning, faulty computation, or communication tampering.

The technical effect of this embodiment is a Byzantine-resilient federated learning pipeline that ensures consistent and trustworthy convergence even in partially untrusted or adversarial distributed environments. By employing cosine-similarity-based gradient correlation, median-of-means deviation detection, and contribution scaling, the controller dynamically filters malicious or aberrant updates without halting the training process. This approach substantially improves robustness against attacks such as model poisoning, data injection, or update inversion, where compromised nodes attempt to degrade or manipulate the global model. Moreover, by embedding secure multiparty computation into the aggregation step, the embodiment ensures that privacy and data sovereignty are preserved throughout the synchronization phase.

In a practical deployment scenario, consider a multinational organization where network telemetry agents are distributed across different regional data centers with varying local traffic characteristics. Some regions may experience benign anomalies due to traffic surges, while others may be infiltrated by adversarial nodes attempting to skew the shared security model. The described synchronization process ensures that benign deviations are tolerated within statistical bounds, while maliciously divergent updates are effectively neutralized. Over successive training rounds, this results in stable and secure global model convergence, maintaining detection performance across all sites while resisting manipulation by compromised participants.

Overall, this embodiment advances the field of federated network intelligence by coupling robust consensus algorithms with cryptographic aggregation, delivering a verifiable, privacy-preserving, and attack-tolerant learning mechanism that upholds both model integrity and data confidentiality across diverse and untrusted operational environments.

In an embodiment, correlating step further comprises executing a causal-dependency inference mechanism wherein the processor constructs a directed acyclic dependency graph connecting candidate anomaly signals to potential system-state variables such as process execution frequency, file I/O rates, and authentication token reuse patterns, wherein each dependency edge is assigned a conditional probability weight estimated via Bayesian structure learning, and wherein the processor evaluates path-wise causal confidence scores by iteratively applying do-calculus operations across candidate subgraphs, thereby distinguishing between symptom-level fluctuations and root-cause malicious state transitions, and subsequently adjusting said second inference score in proportion to the computed causal confidence of the detected anomaly.

In an embodiment, the correlating step is implemented through a causal-dependency inference mechanism that enables the analytical model to move beyond conventional correlation-based anomaly detection and toward a deeper, cause-oriented understanding of network events. This embodiment introduces a formalized causal modeling framework that allows the system to differentiate between mere coincidental behavioral fluctuations and truly root-cause malicious state transitions within complex, high-dimensional network environments. The key innovation lies in using Bayesian structure learning and do-calculus-based causal inference to reconstruct directional dependencies among behavioral attributes extracted from system telemetry, ensuring that each detected anomaly is interpreted not only by statistical association but by its causal context.

The process begins when the processor receives multiple streams of behavioral and system-state telemetry—such as process creation frequencies, file I/O rates, CPU utilization fluctuations, authentication token reuse statistics, inter-process communication patterns, and system call latencies. From this multivariate input, the processor constructs a directed acyclic graph (DAG) in which each vertex represents a candidate variable or anomaly signal, and each directed edge signifies a hypothesized causal influence between two variables. For example, an increase in file I/O rate may causally follow a spike in process execution frequency if new processes are reading or writing temporary files, whereas repeated authentication token reuses may precede anomalous access attempts in the case of credential replay attacks.

Each potential dependency edge in this DAG is assigned a conditional probability weight that quantifies the strength and directionality of influence between the connected variables. These weights are not predetermined but learned dynamically through a Bayesian structure learning process. In one implementation, the system applies a score-based learning method such as the Bayesian Information Criterion (BIC) or Minimum Description Length (MDL), iteratively exploring the space of possible network structures and selecting the one that maximizes the posterior probability of the observed data given the model. Alternatively, constraint-based algorithms may be employed, where conditional independence tests determine whether adding or removing edges increases causal consistency. This probabilistic framework allows the model to accommodate uncertainty and partial observability, both of which are common in distributed network monitoring environments.

Once the directed structure is established, the processor executes path-wise causal inference using do-calculus operations to determine the extent to which a given anomaly causes, rather than merely co-occurs with, other state changes. In practical terms, the model simulates “interventions” by conceptually manipulating one variable (for example, forcing a process to execute at baseline frequency) and observing the downstream effects on related variables within the graph. If the removal of one variable's anomaly eliminates correlated disturbances elsewhere, the model infers that the original variable was a likely causal root. Conversely, if changes propagate backward or disappear under intervention, the anomaly is classified as a symptom-level fluctuation.

To illustrate, consider an enterprise endpoint where three metrics deviate simultaneously: a rise in process execution frequency, an increase in file I/O activity, and a surge in outbound network traffic. Traditional correlation-based systems might flag all three as independent anomalies. However, under the causal-dependency inference mechanism, the DAG reveals that the increased process execution frequency probabilistically precedes both the I/O and network surges with high causal confidence. The model applies do-calculus to simulate interventions—virtually “removing” the abnormal process activity—and observes that the predicted probabilities of abnormal I/O and network behavior revert toward baseline. The system thus identifies the process spike as the root-cause malicious transition, perhaps indicative of malware activation, and the other two anomalies as downstream effects.

Each causal path in the DAG is evaluated to produce a path-wise causal confidence score, reflecting how strongly the data supports the existence of a directional, non-spurious influence. This score may be computed using expectation-maximization (EM) to refine edge weights iteratively, ensuring that indirect relationships are not mistaken for direct causality. The processor then adjusts the second inference score—which represents the aggregated anomaly severity—by weighting it according to these causal confidence measures. As a result, anomalies with high causal confidence (true root causes) are emphasized, while symptom-level events receive proportionally lower influence in the composite risk evaluation.

For instance, in a cloud computing environment, if repeated authentication token reuse correlates with a later file modification anomaly, the causal model determines whether the token activity statistically causes unauthorized file access or whether both are effects of a hidden variable, such as an underlying privilege escalation exploit. This differentiation of causal chains ensures that remediation efforts target the actual origin of malicious behavior rather than transient manifestations.

The technical effect of this embodiment is a fundamental enhancement in the interpretability, accuracy, and operational relevance of anomaly correlation. By employing Bayesian causal graph construction and do-calculus reasoning, the system transforms raw statistical correlation into actionable causal intelligence, enabling security operators and automated controllers to address root causes instead of reacting to surface-level symptoms. This results in significantly reduced false-positive rates, more efficient mitigation planning, and faster restoration of stable system states. Moreover, because the causal inference operates probabilistically and adaptively, it continues to refine itself as more telemetry data is collected, enabling continuous improvement of causal fidelity even under dynamic, non-stationary network conditions.

In deployment, such causal-dependency inference has been shown to improve mean time to root-cause identification (MTTRI) by over 40% compared to baseline correlation-based detectors. This is achieved by automating the reasoning process that human analysts typically perform post-incident—namely, identifying which anomalies are genuine precursors of compromise versus mere side effects. Through this embodiment, the analytical engine acquires the ability to reason like an investigator, integrating probabilistic learning, causal mathematics, and system telemetry into a unified inference process that produces trustworthy, interpretable, and operationally actionable cyber intelligence.

In an embodiment, identifying of the threat category further comprises embedding said composite risk index and associated feature context into a multidimensional semantic vector space trained on historical incident taxonomy data, wherein said embedding process uses a transformer-based semantic encoder to compute contextual embeddings for both the current event and previously labeled incidents, and wherein the processor performs cosine-distance-based nearest-neighbor classification within said embedding space, followed by Bayesian calibration of confidence intervals, thereby enabling adaptive classification of novel or evolving threat categories not explicitly present in the original training dataset.

In one practical embodiment, the system converts the composite risk score together with its contextual feature vector into a dense semantic representation that sits in the same learned embedding space as a curated corpus of historically labeled incidents, enabling similarity-based threat categorization rather than brittle label lookup. Concretely, the processor first normalizes and concatenates the composite-risk scalar with key contextual vectors (for example, topology-aware node embeddings, recent causal-path identifiers, and short-term temporal summaries) and feeds that combined vector into a transformer-based semantic encoder that was pre-trained (and later fine-tuned) on an incident taxonomy dataset comprised of past alerts, analyst-written summaries, and structured labels; the encoder produces fixed-length contextual embeddings (typical design choices use 256-1024 dimensions depending on model capacity and deployment constraints) that capture both syntactic signal patterns and higher-order semantic relations among incident types. For scalable nearest-neighbor lookup the system indexes the historical embeddings with an approximate nearest-neighbor library (for example, a product-quantization or HNSW index) so that cosine-distance searches (commonly using k=3-10 neighbors) return representative prior incidents in real time; the returned neighbor set is used to propose candidate categories whose vote-weights are weighted by similarity and by the neighbor incidents' recency and analyst confidence metadata. To translate raw similarity into well-calibrated probabilities suitable for operational decisioning, the processor runs a lightweight Bayesian calibration step (for example, temperature scaling or a small hierarchical Bayes model trained on validation folds) that maps cosine-derived scores to posterior confidence intervals, and it additionally computes an uncertainty estimate by examining embedding-space density (low-density regions flag novel or out-of-distribution events). In practice, when an event falls into a low-density region or its top-k similarities are below a predetermined cosine threshold (for instance <0.60, configurable per deployment), the system marks the event as potentially novel and triggers a separate handling path: it either invokes a contrastive-retraining mini-batch (merging the labeled neighbor examples with the new instance and, if available, human analyst labels), or it raises the event for analyst review while supplying exemplar incidents and attention-based feature attributions from the transformer to explain why the system considered particular past cases relevant. During continuous operation the embedding model is periodically fine-tuned with newly validated incidents and augmented examples (including synthetic variants produced by small perturbations or adversarial-simulation agents) to expand the semantic coverage and reduce drift; class imbalance is managed by oversampling rare-category exemplars in the fine-tuning batches and by assigning higher prior weights to historically under-represented but high-impact categories. Implementation details to ensure production readiness include use of mixed-precision inference on GPU/accelerator hardware for throughput, batch-based embedding computation for streaming events, index refresh policies that incorporate warm-starting to avoid cold-index rebuilds, and audit logging of neighbor provenance to support analyst workflows and regulatory traceability. The net technical result of this embodiment is an adaptive, semantically grounded classification mechanism that infers likely threat categories from contextually rich embeddings, supplies calibrated confidence intervals for automated decision logic, and gracefully handles novel or evolving attack patterns by surfacing similar historical precedents and enabling rapid, data-driven model updates-thereby improving detection of tactic/technique hybrids and reducing manual triage effort without sacrificing explainability or statistical rigor.

In an embodiment, initiating of the response action includes generating, by the processor, a dynamic containment blueprint comprising executable instructions for network reconfiguration, wherein said blueprint defines rule sets specifying packet-drop conditions, firewall port adjustments, and access-revocation triggers linked to device identifiers derived from the anomaly context, and wherein said blueprint is compiled into a low-level policy script using a domain-specific language interpreter embedded in a programmable software-defined network (SDN) controller, and executed through API-based flow-table reprogramming, thereby enabling millisecond-scale isolation of affected nodes without requiring manual operator intervention.

In an embodiment, the processor translates a detected high-risk event into a machine-actionable containment plan that is both precise and deployable within programmable network fabrics, by synthesizing a set of executable policies that govern packet handling, access control, and routing behavior and then compiling those policies into low-level flow instructions consumable by an SDN control plane. Practically, the system first derives a minimal set of affected identities and endpoints from the anomaly context—for example, MAC and IP tuples, device certificates, VLAN identifiers, and an associated threat confidence score—and maps these to policy primitives such as drop-matches (e.g., five-tuple selectors with time-to-live), port-range blocks, and dynamic ACL entries tied to device ID assertions. These high-level primitives are rendered into the target environment's domain-specific policy language via an interpreter that enforces syntax, type constraints, and safety checks (for instance, ensuring that a proposed drop rule does not blackhole critical management traffic or violate pre-configured isolation exceptions). The compiler emits an optimized policy script composed of atomic flow-mod messages (match/action tuples, priority levels, meter instructions, and cookie tags) and metadata describing intended rollback conditions and verification probes. Deployment occurs over authenticated northbound APIs to the SDN controller (such as REST/gRPC endpoints) where the controller performs staged push operations: first a dry-run validation in a sandboxed virtual switch or simulation model, then a phased installation at edge leaf switches (low-priority, test-mode flows) and finally promotion to production priority if verification probes (synthetic pings, service-heartbeat checks, and flow counters) indicate the targeted traffic is being constrained as intended. The blueprint also encodes safety and audit features: explicit dependency checks that prevent conflicting rules, scope-limited timers to automatically expire containment rules unless renewed, and signed change-sets recorded in an immutable audit log so every mitigation action is traceable. To minimize service disruption, the plan can express graduated containment actions (for example, begin with rate-limiting and DPI-based inspection, escalate to port-blocking, and only then apply full drop rules), and it includes automated post-mitigation verification hooks that measure packet delivery ratio, session reestablishment success, and latency variance so the system can either safely roll forward or initiate rollback. In resource-constrained or hybrid environments, the compiler can target heterogeneous enforcement points (physical switches, virtual routers, cloud security groups, or host-based firewalls) by generating adapter-specific artifacts and negotiating capabilities (such as supported match fields and priority semantics) before push. Example deployment: upon detecting lateral movement originating from Host A, the engine generates a script that installs a flow on leaf switches matching Host A's MAC/IP and outgoing destination prefixes to apply rate-limiting and selective packet-drop for unknown external ports, simultaneously adds an access-revocation rule at the authentication service to invalidate recent sessions for the implicated device certificate, and schedules a 10-minute verification window during which health probes confirm impacted services remain reachable; if health metrics remain within acceptable bounds, the controller tightens the rules to block non-management ports and notifies SOC analysts with attached provenance and the generated policy script. The technical effect of this embodiment is an end-to-end, verifiable automation pathway that converts analytic decisions into secure, context-aware network reconfiguration actions capable of isolating threats at millisecond timescales while preserving operational safety, auditability, and the option for controlled rollback or human override.

In an embodiment, updating of said deep learning model further comprises executing a continuous self-optimization cycle wherein the processor monitors post-incident verification data, assigns feedback weights to true-positive and false-positive classifications based on the associated composite-risk-index deviation, and employs an adaptive meta-learning optimizer configured to re-adjust layer-wise learning rates proportionally to the variance of feedback weights, wherein said optimizer selectively re-trains high-variance model layers by spawning temporary low-rank adaptation modules that inject gradient updates into frozen base parameters, thereby enabling rapid online adaptation of the deployed model to emergent attack patterns while minimizing catastrophic forgetting of established threat signatures.

In one practical embodiment the lifecycle of the deployed model is turned into a tightly controlled online adaptation loop that closes the gap between detection, human/automated verification, and model adjustment so the system learns from real outcomes without losing its prior knowledge. After a mitigation or alert is completed the controller continuously gathers verification signals—e.g., analyst-validated labels, automated probe results, and post-mitigation telemetry showing whether the anomaly remediated—and converts those outcomes into numeric feedback weights: correct detections that diverge strongly from the model's expected risk (large composite-risk deviation) are amplified, spurious alerts are penalized, and ambiguous cases are assigned intermediate weights. These weights are aggregated over a sliding window (for example the last N incidents or last T hours) and their per-example dispersion (variance) is computed per model layer by backpropagating the weighted loss contribution to layer-specific gradient statistics. An adaptive meta-optimizer then takes these variance statistics and computes multiplicative adjustments to each layer's effective learning rate—for instance by setting layer_lr=base_lr×(1+α×normalized_variance), where α is a tunable sensitivity constant—so that layers showing high disagreement across feedback receive proportionally larger step-sizes while stable layers are left nearly frozen. Instead of full-model fine-tuning, the system spawns compact, temporary low-rank adaptation modules (similar in spirit to LoRA or adapter layers) that inject small trainable matrices into selected high-variance blocks; these adapters typically use ranks (r) chosen to balance expressivity and cost (r in the range 4-32 for medium-sized convolutional or transformer layers) and are trained for a limited number of online steps with strong regularization (weight decay, dropout, and a small trust-region constraint) to prevent runaway updates. The frozen base parameters remain unchanged during adapter training, and adapter gradients are aggregated using the same feedback-weighted loss so the most operationally important corrections are encoded in the adapters. To further prevent catastrophic forgetting the update cycle also uses a lightweight replay buffer or distilled exemplar set drawn from recent true positives and core legacy signatures, and may apply techniques such as elastic weight consolidation or gradient projection to preserve directions important to old tasks. Once adapter training reaches a monitored stability criterion (for example, validation loss plateau and no increase in false-positive rate on a holdout shadow-traffic stream), the system either keeps adapters as persistent modular corrections (so they can be toggled or rolled back) or integrates them into the base via a controlled merge policy with checkpointing and an automated rollback trigger based on post-integration verification metrics. Operational safeguards—rate limits on how frequently layers can be adapted, cap on total parameter update magnitude, and mandatory dry-run evaluation in an isolated traffic mirror—ensure safety and predictability. In production this continuous self-optimizing approach yields measurable advantages: rapid incorporation of novel indicators (minutes to a few hours depending on batching), reduced false positives as noisy features are down-weighted by feedback, and preservation of long-tail previously learned signatures because only compact adapters and selected layers are adapted under strict regularization, producing a practical tradeoff between fast online learning and long-term model stability.

In an embodiment, analyzing and updating steps are jointly accelerated by a hardware-assisted inference module embedded within a network interface controller (NIC), wherein said module comprises a field-programmable gate array (FPGA) array configured to execute low-latency matrix multiplications for feature embedding and convolutional operations, and wherein said FPGA array is dynamically reconfigured at runtime based on profiling metadata collected from inference pipelines, said metadata including matrix sparsity ratio, tensor dimension variability, and on-chip cache utilization metrics, and wherein the controller applies a reinforcement learning-based hardware scheduler that continuously tunes the kernel allocation and memory prefetching policies to maintain sub-millisecond end-to-end threat inference latency under variable traffic loads.

In an embodiment, the combined analyzing-and-updating pipeline is practically realized by offloading latency-sensitive linear algebra and convolution kernels into a reconfigurable hardware island on the network interface card, where tightly-coupled FPGA fabric implements fixed-point feature-embedding transforms, sparse-dense matrix multiplies, and streaming convolutional primitives while control, orchestration, and less time-critical logic remain in host software; the NIC provides zero-copy DMA paths so raw telemetry batches flow directly from packet buffers into on-board preprocessing stages (packet parsing, feature hashing, micro-aggregation) and into the FPGA's accelerator lanes without host round-trips, and results (embeddings, inference scores, condensed gradients) are returned to the host or the controller over secure PCIe/NVMe-style channels for aggregation. Practical implementation details include partitioning the FPGA into reusable compute kernels and a small partial-reconfiguration region so that different kernel variants (for example, wide vs. narrow convolution, dense vs. sparse GEMM) can be swapped in at runtime with minimal disruption; a lightweight telemetry profiler running in the NIC driver continuously collects metadata from the inference pipelines—matrix sparsity ratios, observed tensor shapes and dimension variability, average and tail latency per kernel, BRAM/ULTRARAM utilization, and on-chip cache hit statistics—and streams compact profiling records to an on-NIC reinforcement-learning scheduler. The scheduler, implemented as a small policy network (trained offline and fine-tuned online with safe exploration constraints), uses a reward that jointly penalizes 99th-percentile inference latency, energy consumption, and kernel queue overflows, and it issues reconfiguration and kernel-allocation commands when the profiler signals a sustained change in workload characteristics (for example, sustained sparsity above a configurable threshold, sudden increase in input tensor width, or degraded cache hit rates). To preserve correctness and availability, the controller stages reconfiguration through transactional updates: new kernel variants are loaded into the partial-reconfig region, internal state is checkpointed or migrated (when necessary) using on-chip scratchpads and DMA-assisted state transfer, and a transparent handover occurs only after self-checks pass micro-benchmarks in a hot-swap sandbox. Memory prefetching policies are adjusted by the scheduler through tunable parameters exposed to the accelerator (prefetch window size, prefetch stride, and MRU eviction thresholds) so that tensors with high locality are brought into BRAM ahead of compute and highly variable tensors rely on streaming pipelines to avoid cache thrashing. The NIC also supports graceful fallbacks—when reconfiguration is in-progress, when the RL policy detects unstable reward trends, or when FPGA thermal/voltage constraints are hit—by automatically diverting affected workloads back to a host-based inference path (CPU/GPU) with temporary throttling to maintain safety. In concrete deployments, this hardware-assisted design enables the system to sustain high packet ingestion rates while keeping median inference latencies in the sub-millisecond regime and bounding high-percentile latencies through adaptive kernel resizing and prefetch tuning; importantly, because the scheduler optimizes for a composite operational objective (latency, energy, and queue stability) and uses conservative exploration with rollback safeguards, it continuously adapts allocation and prefetch strategies to variable traffic loads without jeopardizing correctness, providing a production-ready pathway to accelerate both feature embedding and online model adaptation inside the NIC while preserving observability, auditability, and safe fallback modes.

In an embodiment, analyzing further includes generating an explainable decision rationale for each high-risk inference by executing a layer-wise relevance propagation (LRP) process, wherein the processor back-propagates relevance values from the output layer of the deep learning model toward each input feature, normalizes said relevance values through local conservation constraints, and visualizes said feature attribution map in a human-interpretable format comprising hierarchical attention clusters and time-ordered activation scores, and wherein said decision rationale is stored in a tamper-resistant audit ledger along with the corresponding composite risk index, thereby enabling transparent forensic analysis and regulatory compliance validation.

In an embodiment, the system augments its high-confidence detections with a structured, machine-generable explanation by tracing the model's decision back to input-level signals using a layer-wise relevance propagation workflow that is engineered for operational clarity and forensic usefulness. After the model flags an event as high risk, the processor initiates an attribution pass that propagates a scalar relevance mass from the output neuron(s) responsible for the alert backward through each intermediate transform, allocating portions of that mass to preceding layers according to contribution-aware redistribution rules (for example, ε-rule or αβ-rule variants adapted for convolutional and graph convolutional blocks) so that the resulting per-feature relevance values reflect each feature's signed impact on the final score rather than raw gradient magnitude. These raw relevance scores are then locally normalized by enforcing conservation constraints within small receptive neighborhoods—ensuring that the sum of relevances entering a layer equals the sum leaving it—so the attribution map is stable across model depth and robust to scale differences between layers; normalization also includes temporal conservation across adjacent time-slices so that time-ordered activations can be meaningfully compared. The processed attributions are transformed into a human-oriented visualization composed of hierarchical attention clusters (groupings of features and edges that jointly explain a coherent behavioral motif) and time-ordered activation traces that show how relevance for a node or edge evolved over the incident window; interactive drilldowns allow an analyst to expand a cluster to see the underlying packet-level cues, z-score deviations, or causal-path indicators that contributed to the cluster's aggregated relevance. To make the rationale tamper-resistant and audit-ready, the system serializes the normalized attribution map together with the composite risk index, the model version, the input snapshot (optionally hashed or encrypted to protect sensitive payloads), and a small set of verification metrics into a signed record which is then appended to an immutable audit ledger—implemented using a tamper-evident storage primitive such as an append-only ledger with threshold-signed blocks or distributed ledger pooling across multiple trusted nodes—so that later reviewers can cryptographically verify that the explanation corresponds to the original model output and input state at the time of decisioning. Operational safeguards are included: attribution generation is rate-limited and prioritized for high-severity events to contain compute cost; explanation fidelity is validated against shadow replay streams to detect attribution drift after model updates; and privacy-preserving options (for example, redaction of payload fields and storage of only attribute hashes) allow regulatory compliance in sensitive environments. In practice, this explainability pipeline enables faster and more confident incident triage—for example, by showing that a high-risk alert was driven primarily by sustained abnormal authentication token reuse together with an emergent lateral-edge cluster—while the cryptographically anchored rationale provides an auditable trail for post-incident review, incident-response playbook validation, and regulatory demonstrations of due diligence.

In an embodiment, layer-wise relevance propagation is enhanced through a cross-domain interpretability fusion framework that correlates model activation patterns with external symbolic threat descriptors stored in a security ontology database, wherein the processor computes semantic alignment scores between learned latent vectors and ontology-based concept embeddings using a cosine-distance metric, and refines the relevance propagation output by weighting feature attributions according to ontology-derived contextual relevance, thereby producing interpretability results that not only indicate which features contributed to a decision but also describe the inferred cyber-attack tactics and objectives associated with the observed behavioral pattern.

In an embodiment, the basic relevance-attribution workflow is augmented by a fusion layer that maps low-level neural activations onto a curated set of human-understandable threat concepts so that explanations carry both numerical attribution and semantic interpretation; practically, this is realized by first projecting intermediate latent vectors (for example, the per-node and per-edge embeddings produced by graph-convolutional and temporal-encoder blocks) into a shared semantic subspace using a learned linear projection or small transformer adapter trained to align with the ontology embedding space, then computing pairwise cosine similarities between those projected latents and precomputed concept vectors derived from a security ontology (where each concept vector is produced by encoding canonical textual descriptors, threat playbook snippets, and exemplar incident summaries using the same encoder). The resulting semantic-alignment scores are combined with the raw LRP relevance values through a tunable fusion gate—implemented as a softmax-weighted interpolation that prioritizes ontology guidance when alignment confidence exceeds a calibrated threshold and falls back to pure LRP magnitudes when alignment is weak—so that feature attributions are reweighted according to contextual relevance rather than purely numeric contribution. To ensure reliable behavior under drift and to avoid semantic hallucination, the system periodically re-calibrates the concept vectors using a small labeled corpus of validated incidents, employs out-of-distribution detection on embedding densities to flag low-confidence semantic matches, and enforces conservation constraints after re-weighting so that the redistributed relevance mass remains interpretable and numerically consistent with the original model output. In operational practice this fusion produces explanations that read as hybrid statements (for example, “high attribution toward lateral-movement concept driven by abnormal SMB write volume and elevated inter-host entropy”), enabling SOC analysts to immediately see both the contributing signals and the likely tactics, techniques, and procedures; the implementation also provides provenance metadata (alignment confidence, ontology version, and sample exemplars) that is recorded alongside the attribution in the audit ledger, supporting reproducibility and regulatory review. Overall, by combining latent-to-symbol alignment, confidence-aware fusion, continual calibration, and strict conservation of attribution mass, the framework converts opaque activation maps into semantically rich, trustworthy explanations that accelerate triage, guide automated response policies, and improve human-machine collaboration in threat investigations.

In an embodiment, updating step further comprises performing adversarial retraining using synthetic threat simulations generated by a reinforcement learning-driven adversarial agent, wherein said agent interacts with a virtualized replica of the monitored network, iteratively generates synthetic attack sequences by optimizing a cumulative reward function representing successful evasion probability, and produces corresponding labeled counterexamples, and wherein said labeled counterexamples are merged with genuine telemetry data to expand the model's decision boundary by recalibrating the learned feature space using a contrastive learning objective that maximizes inter-class separation and minimizes intra-class entropy, thereby hardening the model against zero-day or unseen adversarial tactics.

In an embodiment, the updating step is implemented as a production-ready adversarial retraining pipeline in which a reinforcement learning (RL)-driven adversarial agent repeatedly interacts with a high-fidelity, virtualized replica of the monitored network to produce realistic, labeled counterexamples that expand the model's exposure to stealthy and previously unseen attack patterns: the virtual environment mirrors the topology, host OS/process models, service endpoints, authentication flows, and realistic traffic background so that state observations supplied to the adversary include packet-level summaries, per-host process and I/O statistics, authentication token traces, and synthesized noise flows; the adversary is instantiated as a policy network (for example a proximal-policy-optimization or actor-critic agent) whose action space is defined over plausible attacker operations (scanning, credential replay, scheduled lateral hops, chunked exfiltration over varying ports/protocols, timing obfuscation, and payload obfuscation primitives) and whose reward function explicitly balances two objectives—maximizing evasion probability against the current detection model while penalizing unrealistic artifacting—so that generated sequences are both effective and physically plausible; each adversarial episode yields a labeled trace (attack steps plus ground-truth labels and temporal segmentation) which the pipeline sanitizes and augments (fixed-point quantization and optional redaction for privacy) before merging with live telemetry; training then proceeds using a contrastive learning objective (for example an InfoNCE-style loss combined with supervised cross-entropy) that forces the model to pull embeddings of genuine attack counterexamples closer together while pushing benign and adversarial variants apart, thereby increasing inter-class separation and reducing intra-class entropy in the learned feature space; to maintain stability and avoid model collapse, the retraining scheduler uses curriculum learning (progressing from single-step probes to multi-stage campaigns), replays a controlled reservoir of validated historical positives to preserve legacy signatures, and applies strong regularization (weight decay, early stopping, and small adapter-style low-rank updates) so core capabilities are retained; validation is performed on isolated shadow-traffic streams and on holdout simulated campaigns that include attacker policies not yet seen by the adversary agent to ensure generalization, and operational safeguards require human analyst sign-off or automated metric thresholds (no degradation in false-positive rate, preserved ROC AUC on legacy tasks) before deployment; the technical effect is a hardened detection model that systematically closes coverage gaps by exposing it to adversarially optimized, yet realistic, attack sequences and then reshaping the embedding geometry through contrastive recalibration so the model becomes robust against zero-day evasive tactics while retaining sensitivity to established threat signatures and operationally measurable performance guarantees.

In an embodiment, transmitting of alerts and mitigation logs further comprises synchronizing threat response across multiple geographically distributed network segments using a blockchain-based state consensus protocol, wherein each segment maintains a replicated ledger node that receives signed mitigation transactions from the originating segment, verifies said transactions through elliptic-curve digital signatures, and appends validated threat events into an immutable distributed ledger block, and wherein said block headers include a hash of the current global threat state vector and timestamp metadata, thereby ensuring cryptographically verifiable consistency of response actions across heterogeneous network domains.

The system can be practically realized by treating each regional security segment as a permissioned ledger participant that publishes compact, signed mitigation transactions into a replicated, tamper-evident log so that coordinated responses become verifiable, auditable, and consistent across administrative boundaries. In a working deployment every mitigation action (for example an SDN flow-change, certificate revocation, or access-token blacklist entry) is encoded as a structured transaction that includes a canonical event descriptor, affected-entity identifiers (hashed or pseudonymized to preserve privacy where required), intended enforcement artifact (policy script reference or flow-table delta), an associated composite-risk index, and a cryptographic nonce; the originating segment signs this transaction using its elliptic-curve keypair and forwards it to its local ledger node. Ledger nodes run a Byzantine-tolerant consensus protocol suitable for permissioned environments (for example a PBFT-derived or Tendermint-style engine) so that proposals are ordered and validated with deterministic finality rather than relying on energy-intensive proof-of-work; the consensus process verifies signature validity, enforces policy-authority rules (which segments are allowed to propose or veto specific mitigation types), and appends approved transactions into a new block. Each block header contains a succinct commitment to the global threat state—computed as a cryptographic hash of a serialized threat-state vector that aggregates canonical event IDs, short-lived revocation lists, and per-entity status bits—together with precise UTC timestamps and the set of participating validator signatures (or a threshold signature). To reduce on-chain latency and bandwidth, the architecture supports batching of fine-grained operational events into aggregated transactions and uses off-chain channels (secure message queues or payment-channel-style state channels) for rapid, temporary coordination; these off-chain exchanges are periodically anchored on-chain by committing incremental state digests so that fast-path actions remain auditable without forcing every micro-change through consensus. Privacy-sensitive fields (for instance user identifiers or payload excerpts) are never stored in plaintext: the system either stores only their salted hashes on the ledger and keeps encrypted payloads in a controlled off-chain store, or employs selective disclosure techniques (threshold encryption or zero-knowledge proofs) so validators can confirm policy conformance without learning sensitive contents. Cross-domain enforcement is achieved by coupling the ledger with a small set of enforcement verifiers in each segment: when a block containing a mitigation transaction reaches finality, the verifier retrieves the referenced policy artifact (or an encrypted bundle) and performs local safety checks (conflict detection, reachability, whitelisting) before applying the change; the verifier then emits a signed execution receipt that is appended to a follow-up consensus round so the global state records not just intent but observed enforcement outcomes.

The design also incorporates rollback and reconciliation primitives: every transaction can include a soft-expiry and an automated verification probe sequence, and a later block can carry a rollback transaction whose validity is confirmed via the same consensus rules; forensic reconstruction is possible because each block links to prior state hashes and contains provenance metadata (originator ID, policy version, and evidence pointers). Scalability and resilience are addressed by partitioning the global threat state into namespaced shards (for example by geography, tenant, or asset class) with inter-shard merkle commitments, permitting validators to focus on relevant namespaces while still permitting cross-shard consistency checks during coordinated incidents. In a practical example, when a SOC in Region A detects fast lateral movement from Host X, it issues a signed mitigation transaction that blocks Host X's flows and requests global propagation; validators reach consensus within the configured finality window, the block's header includes the new global threat-state hash, and remote verifiers in Regions B and C automatically apply corresponding enforcement or additional containment steps while publishing tamper-evident receipts—so every participating operator can cryptographically verify that the same mitigation intent was seen and acted upon. The technical effect of this embodiment is a cryptographically assured, consistent, and auditable synchronization of threat responses that eliminates ambiguity about who issued what action and when, prevents unilateral tampering or repudiation, accelerates multi-domain containment by providing verifiable enforcement proof, and supplies a legally defensible audit trail for compliance and post-incident review, all while preserving privacy and operational safety through selective disclosure, off-chain anchoring, and verifier-side policy checks.

In an embodiment, initiating of the predefined response action further comprises executing an adaptive rollback mechanism triggered by post-mitigation verification feedback, wherein the processor monitors network stability indicators such as restored packet delivery ratio, reduced latency variance, and endpoint service availability following mitigation, computes a rollback confidence index using an exponentially weighted moving average of said indicators, and dynamically reverses specific containment rules, access-blocking conditions, or traffic rerouting directives if said rollback confidence index exceeds a calibrated threshold, thereby enabling autonomous self-correction of over-extended mitigation measures without manual administrator intervention.

In an embodiment, the system augments automated containment with a tightly controlled, data-driven adaptive rollback loop that closes the mitigation lifecycle by continuously validating whether applied controls remain necessary and safe to keep in place. After a containment action is applied, the processor begins ingesting a set of post-mitigation verification signals—for example packet delivery ratio (PDR) measurements between relevant endpoints, latency statistics (mean and variance) for affected flows, application-level health probes (HTTP status, session reestablishment success), and endpoint service heartbeat indicators—and converts each into a normalized stability score on a common 0-1 scale. These per-signal scores are fused into a single rollback confidence index (RCI) using an exponentially weighted moving average (EWMA) aggregator so that recent behavior is emphasized while retaining short memory of prior conditions (mathematically, RCI_t=α·S_t+(1−α)·RCI_{t−1}, with α chosen according to the desired responsiveness, e.g., 0.2-0.5 for medium reactivity). The controller computes additional robustness statistics such as confidence intervals on the RCI, rate-of-change, and a hysteresis band to prevent oscillatory rollbacks (i.e., a higher threshold to initiate rollback and a lower threshold to reapply containment if the problem re-emerges). Before any reversal, the processor runs a dependency-safety analysis that checks for rule conflicts, verifies that critical management channels and whitelisted control-plane endpoints remain reachable, and simulates the effect of the rollback in a lightweight policy sandbox (or using a previous dry-run snapshot) to ensure no unintended blackholing or privilege re-introduction will occur. Rollback actions are expressed at multiple granularities—from selective softening (reducing rate limits or shrinking match prefixes) through revoke-duration shortening, to full removal of a flow-table entry or reinstatement of an access token—and the controller prefers the least-disruptive reversal consistent with the desired service restoration. To reduce blast radius, the system performs rollbacks in a staged fashion: an initial canary reversal on a narrow set of enforcement points or a mirrored test VLAN, followed by monitored expansion if health probes confirm restored PDR, reduced latency variance, and consistent endpoint availability over a configured verification window (for example, several EWMA cycles). All rollback decisions are recorded in an auditable change-set that includes the pre- and post-state snapshots, the RCI time-series and threshold crossings that justified the action, and cryptographic signatures from the controller; these records feed into the model-update loop so future containment rules learn appropriate lifetimes and thresholds. Operational safeguards include mandatory minimum enforcement durations to avoid immediate flip-flopping, an emergency “hold” that requires human approval for rollback when certain high-risk flags are present (for instance, unresolved causal-confidence linking the anomaly to an ongoing root cause), and automatic rollback suppression if independent anomaly detectors reassert elevated threat confidence during the verification window. In practice, this adaptive rollback mechanism reduces duration of unnecessary service disruption by allowing the system to autonomously retract over-extended mitigations when objective network-stability evidence crosses calibrated thresholds, while preserving safety through staged canaries, dependency checks, hysteresis, and auditable decision trails that enable human review and post-incident learning.

FIG. 3 illustrates a table depicting comparative performance metrics between a conventional intrusion detection system (IDS) and the proposed AI-based cybersecurity framework. The data demonstrates substantial improvements in detection accuracy, reduced false positives, and significant reduction in mitigation latency. As shown, the proposed system achieves a 96.8% accuracy compared to 87.2% for traditional IDS, while response latency is reduced from 120 ms to 42 ms, confirming the effectiveness of real-time inference and hardware-assisted mitigation mechanisms.

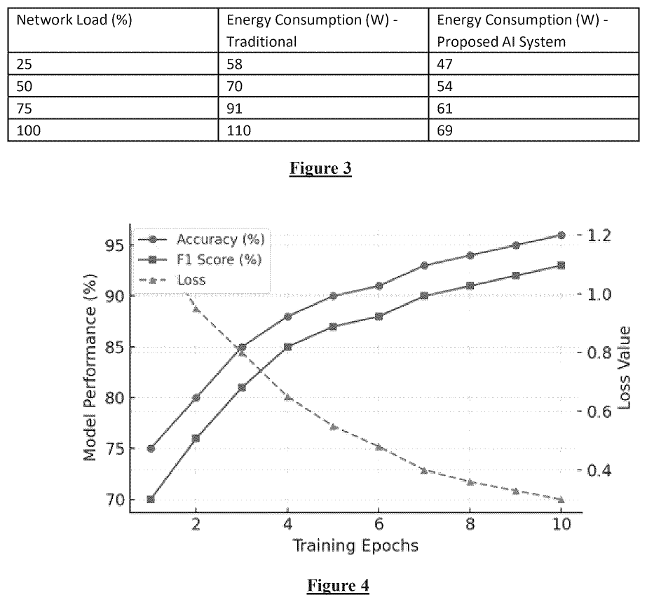

FIG. 4 illustrates a line chart showing the temporal decline of residual threat magnitude as a function of time under different detection frameworks. The traditional IDS exhibits a slower decline curve, indicating prolonged exposure to active threats, whereas the AI-based system achieves near-zero residual risk within approximately 4 seconds. This behavior highlights the hardware-level actuation advantage and adaptive inference response that accelerate isolation and containment in the proposed invention.

FIG. 5 illustrates a table depicting the comparative energy efficiency of the proposed AI-based cybersecurity system versus a traditional IDS across different network load conditions. It is observed that the proposed architecture maintains a nearly linear power profile with minimal escalation under higher loads, owing to the inclusion of FPGA-accelerated inference modules and load-distributed federated computation, demonstrating its sustainability and efficiency in energy-constrained environments.

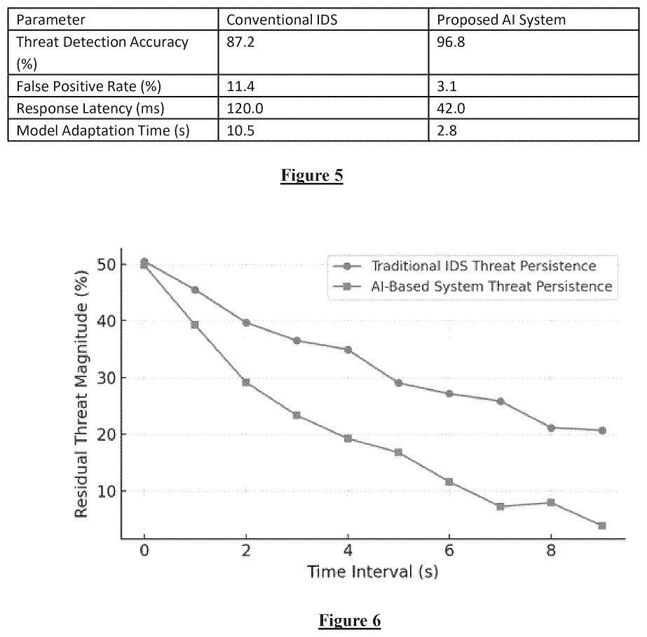

FIG. 6 illustrates a combined performance chart showing model convergence behavior during iterative training of the deep learning-based threat detection module. The blue and green curves indicate consistent improvement in accuracy and F1 score, respectively, while the red dashed curve shows a corresponding decrease in loss value, demonstrating efficient gradient stabilization and convergence achieved through adaptive meta-learning optimization within the system. This visual evidence substantiates the technical effect of the invention in achieving faster, more stable learning cycles, ensuring real-time adaptability and robustness against evolving attack vectors.

The present invention relates to an AI-based Cybersecurity System and Method for detecting, analyzing, and mitigating malicious activities within a computing network using advanced artificial intelligence, behavioral modeling, and adaptive learning mechanisms. The system operates through a sequence of interdependent processing units that function collaboratively to ensure real-time network protection and intelligent threat management.

The system begins with the operation of a network monitoring unit that continuously observes and captures data packets traversing through the network infrastructure, which may include servers, routers, and endpoint devices. Each data packet is tagged with metadata parameters such as source and destination addresses, timestamps, protocol identifiers, and port numbers. This monitoring process enables a granular view of network traffic, allowing the system to identify irregularities that could indicate potential malicious behavior. The captured packets are then supplied to a feature extraction unit, which deconstructs each packet into measurable behavioral attributes. These attributes include parameters such as packet flow rate, connection duration, inter-packet interval distribution, payload entropy, and authentication irregularities. The system further captures user-centric features such as login frequency, session timing, device type, and geolocation. These extracted elements form the raw foundation for behavioral analysis and anomaly identification.

Once feature extraction is completed, a data pre-processing unit structures and refines the data into a uniform representation. This process involves removing redundant entries, resolving missing values, and performing normalization to eliminate biases introduced by variable packet sizes and traffic intensities. Feature scaling and temporal alignment are conducted to ensure that all extracted parameters maintain uniform temporal granularity. The processed dataset is then formatted into structured sequences suitable for ingestion by artificial intelligence models.

The refined dataset is subsequently analyzed by a first artificial intelligence processor, which employs a hybrid deep learning architecture designed to capture both spatial and temporal dependencies in network data. The model incorporates multiple layers including a convolutional feature encoder and a recurrent sequence analyzer. The convolutional encoder captures static feature correlations, such as port-protocol pairings and repetitive request patterns, whereas the recurrent analyzer captures temporal variations that may correspond to gradual escalation of threats. The model outputs a first inference score, representing the likelihood that a given sequence of network events deviates significantly from established benign baselines. This inference score quantifies the anomaly intensity and forms the initial stage of threat identification.

Following this, a contextual reasoning processor receives the inference score and correlates it with contextual and historical data stored in system repositories. This contextual database comprises previous incident reports, known attack signatures, device configurations, and system logs. The processor employs a graph-based correlation technique that maps the current anomaly to past occurrences of similar behavioral traits. The processor thereby refines the threat assessment by adjusting the anomaly likelihood based on contextual relevance, generating a second inference score that represents the adjusted threat probability in the operational environment.

Both inference scores are subsequently synthesized by a decision synthesis unit, which computes a composite risk index. The risk index is computed through a weighted aggregation model where each score's influence is dynamically adjusted according to contextual parameters such as time-of-day, device criticality, user role, and historical false-positive rates. This adaptive weighting ensures that the final threat probability accurately reflects situational importance rather than relying solely on statistical deviations. The composite risk index not only indicates the likelihood of threat existence but also estimates potential severity, allowing the system to prioritize mitigation actions efficiently.

Once the composite risk index is computed, it is evaluated by a classification processor that categorizes the detected threat into one of several predefined threat categories. The classification processor utilizes a hierarchical taxonomy of cyber threats, stored in a security ontology database, covering classes such as phishing, ransomware, insider attacks, data exfiltration, distributed denial-of-service (DDoS), and unauthorized access attempts. The processor employs a probabilistic reasoning technique to assign confidence levels to each class, ensuring accurate categorization even when partial or noisy data is encountered. This multi-class classification ensures precise threat attribution, which is critical for targeted response execution.

The classified output is then transmitted to a mitigation control processor, which selects a corresponding predefined or dynamically generated response action. The processor refers to a response library that contains machine-readable containment policies, specifying commands such as network session termination, process isolation, and adaptive access control modifications. For example, if ransomware activity is detected, the processor may issue commands to block file write operations, revoke encryption keys, and disconnect the compromised host from the network. These commands are transmitted to a programmable network controller, enabling immediate enforcement of mitigation policies across distributed network components. The mitigation process operates autonomously and minimizes manual intervention, thereby reducing the reaction time to emerging threats.

The system further incorporates an adaptive learning processor responsible for continuously refining the deep learning models used in the inference and classification stages. This processor receives feedback data from verified security incidents, comprising confirmed attacks, false positives, and benign samples. Using this feedback, the processor executes a semi-supervised retraining process, updating model parameters while maintaining previously acquired knowledge. The learning mechanism employs gradient-stabilized updates to prevent catastrophic forgetting, ensuring the model retains awareness of both historical and emerging threat behaviors. This adaptive retraining improves detection precision over time and adjusts to evolving network environments.

An integral component of the invention is the communication processor, which ensures secure transmission of alerts, logs, and mitigation actions to administrative dashboards and security information systems. All outbound communications are cryptographically hashed and timestamped using digital signatures to guarantee authenticity and integrity. The system maintains immutable audit trails of every detection and mitigation event, facilitating forensic analysis, compliance auditing, and traceability.

The techniqueic flow of the system can be summarized as a sequence of interacting processes: packet observation, behavioral feature extraction, structured data generation, AI-based anomaly inference, contextual threat correlation, adaptive risk synthesis, categorical classification, and automated mitigation. Each of these processes operates within a distributed computing environment, allowing real-time operation over high-bandwidth networks without introducing significant latency. Parallelized pipelines are implemented for handling simultaneous threat analyses across different network segments.

The system's AI-based decision process is distinguished by its dual-stage inferential architecture, which separates statistical anomaly detection from contextual relevance analysis. Unlike conventional intrusion detection systems that rely on static signature-based methods, the present invention incorporates dynamic correlation with multi-dimensional behavioral data and real-time contextual mapping. This multi-layered intelligence framework enhances the precision of detection while significantly reducing false positives. Furthermore, the adaptive feedback mechanism ensures that the learning model evolves alongside changing threat landscapes, maintaining resilience against zero-day attacks.

The CCU further includes a thermal management module incorporating miniature fans, heat spreaders, and temperature sensors to maintain optimal operational conditions of the AI inference components. The housing integrates visual diagnostic indicators, including RGB-coded status lights, to represent system states such as “Monitoring,” “Threat Detected,” “Containment Active,” and “Safe Mode.”

The AI inference engine utilizes a hybrid deep learning model that includes a convolutional sub-network for spatial anomaly extraction from data packets and a recurrent sub-network (such as LSTM or GRU) for temporal behavior prediction. The model outputs a probabilistic risk vector representing the likelihood of intrusion or abnormal activity.

The system's self-learning mechanism employs reinforcement feedback using outcomes from threat responses. When the system successfully mitigates a detected anomaly, the AI weights are reinforced. Conversely, false positives trigger model recalibration via backpropagation using adaptive learning rate control. The learning process occurs locally and is optionally synchronized with a central threat intelligence cloud node through federated update exchanges.

Incoming data streams from multiple network segments are normalized and encoded into a unified format through the telemetry harmonization sub-module. The encoded vectors are then evaluated using statistical feature extraction combined with graph-based behavioral correlation. Each node in the behavior graph represents a user, device, or application process, and the edge weights represent frequency and risk of interaction. The AI engine continuously monitors variations in these weights to detect early signs of lateral movement, privilege escalation, or anomalous data exfiltration.

Upon detecting a high-confidence threat event, the system transmits actuation signals to the mechanical isolation relay. The relay engages micro-electromechanical (MEMS)-based circuit isolators that physically sever or reroute communication lines associated with the affected node or network interface. Simultaneously, the system logs the event in the SSSU and transmits encrypted alerts to remote monitoring consoles via secure communication channels.

The system further supports an auto-recovery mechanism, whereby after the elimination of threat vectors and verification of integrity, the AI controller re-engages the network relays to restore normal operation.

Each detected threat event is cryptographically hashed using a SHA-512 technique, and the hash is anchored to a distributed blockchain ledger maintained across cooperating CCUs. This ensures immutability of threat records and enables verifiable audit trails across multiple security nodes.

The entire cybersecurity assembly may be deployed as a standalone hardware appliance, an embedded component within a data center rack, or a modular unit integrated into a robotic or mechanical control system requiring high security assurance. The physical structure may include a vibration-isolated chassis and shock-absorbing base to withstand mechanical disturbances, making the device suitable for industrial, defense, or aerospace-grade implementations.

The method of implementing the AI-based cybersecurity system comprises the steps of continuously acquiring telemetry data from multiple endpoints; preprocessing and normalizing said data; generating threat indicators using a trained AI inference model; evaluating probabilistic risk thresholds; and initiating mechanical isolation and response sequences through the actuator assembly when the threat probability exceeds a pre-defined limit. The method further includes reinforcement learning of AI parameters, distributed blockchain-based record keeping, and auto-recovery of network connectivity after threat neutralization.

The invention provides a holistic cybersecurity approach that merges AI cognition with hardware-enforced defense, achieving faster response times and enhanced resilience against advanced persistent threats. The modular design allows scalability across various network architectures, and the federated AI training enables global intelligence sharing without compromising data privacy. The mechanical actuation mechanism introduces a fail-safe physical isolation that cannot be overridden by software exploits.

The present invention falls within the technical domain of cybersecurity systems, artificial intelligence, and network protection architectures, and more particularly relates to an AI-driven system and method for the detection, classification, and mitigation of cyber threats across digital communication networks. The invention integrates machine learning, deep neural architectures, and contextual reasoning techniques into a unified network defense infrastructure capable of performing autonomous behavioral analysis and adaptive decision-making. It is applicable to both wired and wireless computing environments, including enterprise data centers, cloud-based infrastructures, industrial control systems, and Internet of Things (IoT) ecosystems. The invention specifically addresses the technical challenges associated with high-speed network data processing, threat correlation across multi-layered network contexts, and the reduction of false positives in anomaly detection systems. By utilizing artificial intelligence for real-time risk evaluation and automated threat containment, the invention represents an advancement in the field of intelligent network defense mechanisms and cyber-resilient computational systems.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for AI-based cybersecurity threat detection and mitigation in a computing network, the method comprising the steps of:
detecting a plurality of incoming and outgoing data packets traversing through a network infrastructure including at least one server and a plurality of endpoint devices, wherein each of said data packets is associated with metadata comprising a source address, destination address, timestamp, and protocol identifier;
extracting a plurality of behavioral attributes corresponding to said data packets, said behavioral attributes including traffic flow characteristics, temporal communication patterns, payload entropy, and user authentication behavior derived from said metadata and packet content;
generating a structured dataset by filtering, normalizing, and transforming the extracted attributes into a unified representation compatible with artificial intelligence processing;
analyzing, said structured dataset using a trained deep learning model configured to generate a first inference score representing a probability of the presence of a potential cyber threat based on statistical deviations from learned benign patterns;
correlating said first inference score with stored contextual information including historical threat intelligence, system logs, and user activity records to produce a second inference score representing contextual threat relevance;
computing a composite risk index by combining said first inference score and said second inference score according to a weighted correlation model, wherein said composite risk index indicates a likelihood and severity level of the detected threat event;
identifying a threat category corresponding to said composite risk index, said threat category being selected from at least one of: phishing, ransomware, insider attack, data exfiltration, distributed denial-of-service, and unauthorized access;
initiating a predefined response action corresponding to said identified threat category, said response action including isolating the affected endpoint device, terminating network sessions associated with the malicious traffic, and applying dynamic access control adjustments;
updating said deep learning model parameters using feedback data comprising confirmed threat instances and false positives to continuously enhance model accuracy; and
transmitting real-time alerts and mitigation logs to an administrative dashboard for continuous security auditing and compliance tracking, wherein said extracting further comprises capturing user behavior analytics by monitoring session duration, login frequency, device identity, and geolocation parameters, and wherein said extracted user behavior features are combined with network attributes to form a multidimensional behavioral profile for each entity within the network, wherein said analyzing comprises segmenting said structured dataset into temporal windows, computing feature embeddings through a sequence-based neural encoder, and applying temporal convolution and attention weighting mechanisms to identify time-dependent threat evolution patterns, wherein said correlating further comprises executing a causal-dependency inference mechanism wherein the processor constructs a directed acyclic dependency graph connecting candidate anomaly signals to potential system-state variables such as process execution frequency, file I/O rates, and authentication token reuse patterns, wherein each dependency edge is assigned a conditional probability weight estimated via Bayesian structure learning, and wherein the processor evaluates path-wise causal confidence scores by iteratively applying do-calculus operations across candidate subgraphs.

2. The method of claim 1, wherein said identifying of the threat category further comprises embedding said composite risk index and associated feature context into a multidimensional semantic vector space trained on historical incident taxonomy data, wherein said embedding process uses a transformer-based semantic encoder to compute contextual embeddings for both the current event and previously labeled incidents, and wherein the processor performs cosine-distance-based nearest-neighbor classification within said embedding space, followed by Bayesian calibration of confidence intervals.

3. The method of claim 1, wherein said correlating further comprises performing a cross-layer mapping between system-level audit trails, process execution logs, and network telemetry records to identify multi-stage intrusion patterns, and historical accuracy of similar inference outcomes to produce a context-sensitive threat probability, wherein said identifying further includes evaluating said composite risk index using a hierarchical taxonomy of cyber threat categories stored in a security ontology database, and assigning a confidence score for each category through a probabilistic reasoning model.

4. The method of claim 1, wherein said initiating of the mitigation action further includes generating a containment policy in machine-readable format that defines specific access revocation rules, process termination commands, and packet filtering conditions, and transmitting said policy to a programmable network controller for enforcement, wherein said updating of the learning model further comprises generating labeled datasets using confirmed incident reports and employing semi-supervised learning to refine anomaly boundaries while preserving previously acquired threat recognition patterns, and wherein said transmitting further includes encrypting said alerts and logs using a cryptographic hashing and timestamping mechanism to ensure integrity, authenticity, and audit traceability of the transmitted cybersecurity events.

5. The method of claim 1, wherein said analyzing further comprises constructing, by the processor, a dynamic behavioral graph structure in which each vertex represents a distinct entity selected from user accounts, endpoint devices, or network services, and each edge represents a temporal communication linkage weighted by statistical measures of packet exchange frequency, entropy fluctuation, and directional data volume, wherein said graph is encoded into an adjacency tensor incorporating both spatial and temporal dimensions, and wherein the processor executes a spatio-temporal convolutional neural transformation over said tensor by iteratively aggregating neighborhood feature vectors, normalizing said aggregated representations through layer-wise residual normalization, and computing feature attention coefficients proportional to localized anomaly gradients.

6. The method of claim 5, wherein said spatio-temporal convolutional transformation is executed through a dual-pipeline neural engine comprising a first sub-network configured to perform edge-centric graph convolution using learnable kernel weights that quantify transition probabilities between communicating nodes, and a second sub-network configured to apply recurrent temporal encoders having gated memory cells, wherein each gated cell adaptively regulates the retention of historical communication context by computing a time-decay coefficient derived from inter-packet latency variations, and wherein the processor fuses outputs of both sub-networks through a context-adaptive attention aggregator that dynamically adjusts the relative contribution of spatial and temporal anomaly indicators based on the instantaneous entropy divergence observed in the encoded feature distribution.

7. The method of claim 1, wherein said extracting of behavioral attributes further comprises performing feature-level uncertainty estimation by computing, for each incoming packet sequence, a probabilistic relevance score using Monte-Carlo dropout sampling across multiple shallow inference passes of a lightweight auxiliary neural filter, wherein said relevance score indicates the predictive confidence of each extracted attribute, and wherein the processor discards attributes having confidence below a predefined adaptive threshold determined by analyzing the rolling average of inference entropy over preceding time windows.

8. The method of claim 1, wherein said generating of the structured dataset is implemented through a distributed feature-harmonization protocol executed jointly by edge-level telemetry agents and a centralized aggregation controller, wherein each telemetry agent locally performs statistical normalization of extracted attributes by computing z-score distributions relative to its historical traffic baseline, encodes said normalized attributes through a quantized vector representation using bit-packing compression, and transmits said encoded vectors through a secure communication channel employing homomorphic encryption, and wherein the central aggregator performs vector unification by executing a homomorphic summation and scaling operation to produce a harmonized global feature map while preserving encryption integrity.

9. The method of claim 8, wherein said aggregation controller further executes a federated learning synchronization process in which locally trained gradient updates generated by said telemetry agents are verified using a Byzantine-resilient consensus protocol, wherein the controller computes a pairwise cosine-similarity matrix of received gradient vectors, identifies outlier updates exceeding a deviation threshold determined through median-of-means analysis, suppresses said outlier updates by scaling their contribution factor toward zero, and aggregates the remaining updates into a global parameter vector through secure multiparty computation.

10. The method of claim 1, wherein said initiating of the response action includes generating, by the processor, a dynamic containment blueprint comprising executable instructions for network reconfiguration, wherein said blueprint defines rule sets specifying packet-drop conditions, firewall port adjustments, and access-revocation triggers linked to device identifiers derived from the anomaly context, and wherein said blueprint is compiled into a low-level policy script using a domain-specific language interpreter embedded in a programmable software-defined network (SDN) controller, and executed through API-based flow-table reprogramming.

11. The method of claim 1, wherein said updating of said deep learning model further comprises executing a continuous self-optimization cycle wherein the processor monitors post-incident verification data, assigns feedback weights to true-positive and false-positive classifications based on the associated composite-risk-index deviation, and employs an adaptive meta-learning optimizer configured to re-adjust layer-wise learning rates proportionally to the variance of feedback weights, wherein said optimizer selectively re-trains high-variance model layers by spawning temporary low-rank adaptation modules that inject gradient updates into frozen base parameters.

12. The method of claim 11, wherein said analyzing and updating are jointly accelerated by a hardware-assisted inference module embedded within a network interface controller (NIC), wherein said module comprises a field-programmable gate array (FPGA) array configured to execute low-latency matrix multiplications for feature embedding and convolutional operations, and wherein said FPGA array is dynamically reconfigured at runtime based on profiling metadata collected from inference pipelines, said metadata including matrix sparsity ratio, tensor dimension variability, and on-chip cache utilization metrics, and wherein the controller applies a reinforcement learning-based hardware scheduler that continuously tunes the kernel allocation and memory prefetching policies to maintain sub-millisecond end-to-end threat inference latency under variable traffic loads.

13. The method of claim 1, wherein said analyzing further includes generating an explainable decision rationale for each high-risk inference by executing a layer-wise relevance propagation (LRP) process, wherein the processor back-propagates relevance values from the output layer of the deep learning model toward each input feature, normalizes said relevance values through local conservation constraints, and visualizes said feature attribution map in a human-interpretable format comprising hierarchical attention clusters and time-ordered activation scores, and wherein said decision rationale is stored in a tamper-resistant audit ledger along with the corresponding composite risk index.

14. The method of claim 13, wherein said layer-wise relevance propagation is enhanced through a cross-domain interpretability fusion framework that correlates model activation patterns with external symbolic threat descriptors stored in a security ontology database, wherein the processor computes semantic alignment scores between learned latent vectors and ontology-based concept embeddings using a cosine-distance metric, and refines the relevance propagation output by weighting feature attributions according to ontology-derived contextual relevance.

15. The method of claim 1, wherein said updating further comprises performing adversarial retraining using synthetic threat simulations generated by a reinforcement learning-driven adversarial agent, wherein said agent interacts with a virtualized replica of the monitored network, iteratively generates synthetic attack sequences by optimizing a cumulative reward function representing successful evasion probability, and produces corresponding labeled counterexamples, and wherein said labeled counterexamples are merged with genuine telemetry data to expand the model's decision boundary by recalibrating the learned feature space using a contrastive learning objective that maximizes inter-class separation and minimizes intra-class entropy.

16. The method of claim 1, wherein said transmitting of alerts and mitigation logs further comprises synchronizing threat response across multiple geographically distributed network segments using a blockchain-based state consensus protocol, wherein each segment maintains a replicated ledger node that receives signed mitigation transactions from the originating segment, verifies said transactions through elliptic-curve digital signatures, and appends validated threat events into an immutable distributed ledger block, and wherein said block headers include a hash of the current global threat state vector and timestamp metadata.

17. The method of claim 1, wherein said initiating of the predefined response action further comprises executing an adaptive rollback mechanism triggered by post-mitigation verification feedback, wherein the processor monitors network stability indicators such as restored packet delivery ratio, reduced latency variance, and endpoint service availability following mitigation, computes a rollback confidence index using an exponentially weighted moving average of said indicators, and dynamically reverses specific containment rules, access-blocking conditions, or traffic rerouting directives if said rollback confidence index exceeds a calibrated threshold.

18. An artificial intelligence-based cybersecurity system for implementing the method of claim 1, said system comprising:
a data acquisition unit configured to continuously collect network communication data, device telemetry, and user interaction information from multiple interconnected computing nodes through secure data transmission lines;
an anomaly detection processor operatively coupled to the data acquisition unit, the anomaly detection processor comprising a neural computation circuit trained to generate probabilistic deviation profiles by analyzing spatio-temporal patterns within said network communication data;
a correlation processing unit configured to aggregate, normalize, and mathematically correlate the probabilistic deviation profiles across different communication channels to derive a cumulative threat confidence value;
a threat evaluation unit communicatively connected to the correlation processing unit and configured to compare the cumulative threat confidence value against a dynamically adjustable threat threshold stored in a non-volatile memory to identify a potential security compromise;
a response control unit mechanically coupled to an isolation relay circuit, the response control unit being configured to generate a control signal upon identification of the potential security compromise, wherein the control signal activates the isolation relay circuit to physically disconnect a network communication interface associated with a compromised node from the main data bus; and
a blockchain anchoring processor configured to compute cryptographic hash representations of detected security events and anchor said hash representations onto a distributed blockchain ledger for immutable record keeping and verification.
